(19) United States
(12) Patent Application Publication
(10) Pub. No.: US 2025/0376224 A1
(43) Pub. Date: Dec. 11, 2025

(54) ADAPTABLE CARGO SUPPORT ASSEMBLY WITH IMPROVED EXPANSION CONTROL

(71) Applicant: Decked LLC, Ketchum, ID (US)

(72) Inventors: Brian Stevens, St. George, UT (US); Jordan Daniel Lanning, Ketchum, ID (US); Dan Giddings, St. George, UT (US); Spencer Robert Dahl, Ketchum, ID (US); William Banta, Ketchum, ID (US)

(21) Appl. No.: 18/736,085

(22) Filed: Jun. 6, 2024

(51) Int. Cl. B62D 33/08; B62D 33/027

(52) U.S. Cl. CPC B62D 33/08; B62D 33/0273

(57) ABSTRACT

A cargo support includes: a tray; tray rails fastened to the tray and extending longitudinally and parallel to each other; and a base frame that includes base rails that extend longitudinally and parallel to each other. The rails are slidable relative to one another for sliding the tray longitudinally relative to the base frame in an expansion direction transitioning the cargo support from a retracted state of the cargo support to expanded states, and in a retraction direction transitioning the cargo support from the expanded states to the retracted state. The tray has a handle at a tailgate end including a control of a latch for locking in one of the states. Rollers supporting the tray rails have differently sized grooves. Different pairs of bores at different coordinates are provided for variable installation heights of the rollers. A stiffener is used for cargo supports rated for having higher weight ratings.

### FIELD OF INVENTION

The present disclosure relates to features of a cargo support that simplifies use of the cargo support, facilitates safer operation of the cargo support, and simplifies assembly of the cargo support.

### BACKGROUND

A cargo support is a system that can be installed on a floor of a truck, such as a pickup truck, van, etc., which floor is usable for carrying cargo, often heavy construction materials, machinery, or oversized equipment. For example, a contractor may transport such cargo on the floor of a flatbed truck. However, it can be difficult to maneuver such cargo onto and off the flatbed floor, for example due to sidewalls of the truck which impede access to the cargo from certain angles. The cargo support system simplifies loading and offloading cargo onto and off the vehicle floor. The cargo support includes base rails fixed to the floor of the vehicle, tray rails that are slidably coupled to the base rails so that the tray rails can glide relative to the base rails, and a tray to which the tray rails are fixed. The tray can thereby be rolled from a retracted position in which the tray is entirely within the sidewalls of the truck to an expanded position in which at least a portion of the tray is pulled rearward clear of the sidewalls of the truck. (Alternatively, the tray can be partially clear of the sidewalls even in the most retracted position of the tray, but a greater portion of the tray is clear of the sidewalls in the expanded position than in the retracted position.) The cargo support thereby allows a user to easily slide heavy cargo into and out of the truck without having to crawl into the truck and onto the floor of the truck to do so.

FIG. 1 shows a truck 100 having sidewalls 102a and 102b and a floor 104, and shows a cargo support that includes a tray 105 in a retracted position in which the tray 105 is entirely between the sidewalls 102a and 102b. FIG. 2 shows the cargo support with its tray 105 in an expanded position in which a majority of the length of the tray 105 is clear and rearward of the sidewalls 102a and 102b, and further shows a left base rail 107a (the right base rail not shown, it being obscured by the sidewall 102b) fixed to the floor 104 of the truck 100, with the left base rail 107a and the right base rail being exposed due to the sliding of the tray rails (not shown) relative to the left base rail 107a and the right base rail 107b.

The truck 100 additionally includes a tailgate 106, which can be moved between a closed vertical position (not shown), blocking the rearward sliding of the cargo support and an open horizontal position shown in FIGS. 1 and 2, in which the cargo support is free to slide rearward over the interior face of the tailgate 106 from the retracted position of FIG. 1 to the expanded position of FIG. 2. This requires the underside of the tray 105 and the tray rails, which are fixed to the underside of the tray 105, to be positioned at a height at which the bottom of at least the portion of the tray rails that are to be rolled over the interior face of the tailgate 106 is vertically clear of the interior face of the tailgate 106 when the tailgate 106 is horizontally positioned, i.e., higher than all of at least the portion of the face of the tailgate 106 over which the at least the portion of the tray rails are to be slid.

### SUMMARY

Example embodiments of the present invention are directed to improving safety and ease of use of the cargo support. Example embodiments are directed to an improved grip for a user to be able to easily slide the tray. Example embodiments are directed to providing a user with improved control for sliding the tray into various positions of extension and for securing the tray at those positions of extension. Example embodiments are directed to a handle in a prominent position at the tailgate side of the tray, the handle having integrated therein a lever that is easily pulled as part of a pulling of the tray in the tailgate direction, which pulling of the lever causes a pulling of a cable that, in turn, pulls a latch against the force of a spring and away from one of a plurality of catches arranged at the different positions of extension, thereby releasing the tray from a respective one of the different positions of extension.

Example embodiments of the present invention are directed to a feature by which the cargo support can be flexibly installed, for example, so that the cargo support can be installed in any of a plurality of vehicles which differ from each other, for example, with respect to one or more dimensions. For example, the cargo support can be installed in different vehicles whose respective tailgate interior faces, when in the open horizontal position, are at different heights relative to their flatbed floors, with the tailgate end of the cargo support tray being positioned at different respective vertical distances from the flatbed floor in the different vehicles, in order to keep the height of the tailgate end of the cargo support as vertically close as possible to the flatbed floor in each case.

In an example embodiment, the tailgate sides of the base rails each includes bores at different heights of the rails, supports for the tray rails being fastened to the base rails via either (i) the lower bores for the case in which the cargo support is installed in a vehicle whose interior face of the tailgate, when in the horizontal position, is at a first vertical distance from the flatbed floor or (ii) the higher bores for the case in which the cargo support is installed in a vehicle whose interior face of the tailgate, when in the horizontal position, is at a second vertical distance from the flatbed floor, which is higher than the first vertical distance. In an example embodiment, in order ensure sufficiency of the strength of base rails at the position of the bores to carry the supports, the bores at the different heights are laterally offset from each other, so that the two bores are not directly on top of each other, which would otherwise cause a weakness of the base rails at positions of the bores due to a lack of material of the base rails at those positions.

Example embodiments of the present invention are directed to improving components of the cargo support for ease of manufacture. For example, example embodiment are directed to component improvement with respect to ease of selecting, for the same components of the cargo support, between different versions of the cargo support into which to incorporate those same components, the different versions being interchangeably selectable for incorporation therein of those components. For example, various components to be incorporated into the cargo support during the manufacturing process can be selectively assembled selectively into any one of a plurality of predefined versions of the cargo support that differ, for example, with respect to length of the tray or weight capacity of the tray.

For example, example embodiments provide a manufacturing kit having various components that can be installed as the cargo support, where the kit includes stiffeners, which can be installed in certain instances of the installed cargo support, but not installed in other instances of the cargo support. The stiffener can be attached to the base rail at a region of the base rail at which there is maximum moment at full extension of the tray, i.e., a fulcrum point of the base rail at which there is the greatest moment of rotation of an axle carrier of the tray rail against the base rail. When the cargo support is installed with a tray rail intended for supporting lower loads, the moment of rotation of the tray rail against the base rail is not expected to be so great as to deform the base rail, and therefore the stiffener can be dispensed with. On the other hand, when the cargo support is installed with a tray rail intended for supporting greater loads, the moment of rotation of the tray rail against the base rail may be expected to reach to be so great as to deform the base rail without installation of the stiffener, and therefore the stiffener would be installed in such instances. The stiffener, when installed, strengthens the base rail at the region of attachment of the stiffener, to prevent deformation of the base rail by the moment of rotation of the tray rail even when the tray is fully extended to its most extended position while carrying the highest loads for which the cargo support is rated.

In an example embodiment, the base rails are in the form of c-channels, such that, in cross-section, the base rail has the shape of a ‘c’ with the opening of the ‘c’ facing upwards, the opening being bordered on each lateral side thereof by a respective lip edge of the ‘c’ and the opening forming a mouth in which a bottom of the tray rail is received and slides, with laterally extending sections of an axle carrier of, or attached to, the tray rail extending laterally inside the c-channel under the lip edges of the c-channel, thereby holding the tray rail to the base rail.

In an example embodiment, the tray rails of the cargo supports rated for lower loads have a same width as, but a lower height than, the tray rails of the cargo supports rated for the greater loads. For example, in an example embodiment, the tray rails of the cargo supports rated for the lower loads have a height of 1.5″ and width of 1.5″ and are rated for loads as great as 600 pounds, and the tray rails of the cargo supports rated for the greater loads have a height of 2″ and width of 1.5″ and are rated for loads as great as 1000 pounds. It is noted, however, that other heights can be used for still other weight ratings, and/or materials can be selected out of which to form the tray rails for still other weight ratings, and/or stiffener configurations can be implemented for still other weight ratings, and/or other weight ratings can be implemented for cargo supports with a reduced length since there is less torque generated by the weight of the cargo with a shortening of the lever arms formed by the expanded tray rails.

In an example embodiment, the stiffener includes a notch for fitting around part of a stop pin or around a position of attachment of the stop pin, the stop pin being located in the c-channel and preventing further extension of the tray beyond its intended maximum extension, the stop pin therefore being approximately at the location at which the greatest moment of rotation of the tray rail can occur.

As another example, example embodiments of the present invention are directed to component improvement by which to enhance tolerance allowances for manufacturing, for example with respect to thickness of the tray and/or component alignment.

Example embodiments of the present invention are directed to components structured to decrease instances of binding in which sliding of the tray is obstructed from occurring smoothly or from occurring at all, for example due to an unevenness of the base rails and/or tray rails, and/or due to a misalignment between right rails to the left rails and/or between the base rails to the tray rails, and/or due to minor angle and/or out-of-square issues.

For example, in example embodiments, the supports for the tray rails are in the form of rollers or spindles that are centrally grooved, so that the center region of each of the rollers has a smaller radial extension than the edge regions thereof. Each of the tray rails is supported in the central groove of one or more of the rollers at one of the lateral sides of the cargo support, the left one of the tray rails being supported for sliding in the central groove of one or more of the rollers installed on the left base rail and the right one of the tray rails being supported for sliding in the central groove of one or more of the rollers installed on the right base rail. However, the lateral extension of the central groove of at least one of the rollers, e.g., at least the one of the rollers most proximal to the tailgate side of the base rails, installed on one of the base rails is less than the lateral extension of the central groove of at least one of the rollers, e.g., at least the one of the rollers most proximal to the tailgate side of the base rails, installed on the other of the base rails. In this way, the roller having the laterally narrower groove provides good guidance of the tray rail, preventing lateral shaking/movement of the tray during extension or retraction of the tray, while the laterally wider groove of the roller at the other base rail provides enough give to allow for manufacturing and/or installation tolerances, for example, in which there is some misalignment of the rails to one another, for example with respect parallelism. As the tray rail at the one side is guided without wobbling within the roller having the narrower groove, the trail rail at the other side can laterally shift within the wider groover of the roller at the other side as the tray is being rolled in the extension or retraction directions, if necessary due to slight misalignments.

According to an example embodiment of the present invention, a cargo support includes: a tray that has a top face, a bottom face, first and second sides that extend laterally, and third and fourth sides that extend longitudinally; a first tray rail that is coupled directly or indirectly to the bottom face of the tray; a second tray rail that is coupled directly or indirectly to the bottom face of the tray and that extends longitudinally and parallel to the first tray rail; and a base frame that includes a first base rail and a second base rail that extend longitudinally and parallel to each other and that each has a first end and a second end. The base frame including bores via which the base frame is fastenable to a flatbed floor of a vehicle. The first and second tray rails are slidable relative to the first and second base rails, respectively, so that the tray is longitudinally slidable relative to the base frame in an expansion direction and in a retraction direction. In the expansion direction, the cargo support transitions from a retracted state of the cargo support to one or more expanded states of the cargo support in which the first side of the tray shifts towards the second ends of the first and second base rails and the second side of the tray shifts away from the second ends of the first and second base rails. In the retraction direction, the cargo support transitions from the one or more expanded states to the retracted state in which the first side of the tray shifts towards the first ends of the first and second base rails and the second side of the tray shifts towards the second ends of the first and second base rails. The tray has a cutout in a region of the tray that is at the second side of the tray for a handle that is pullable for initiating a sliding of the tray in the expansion direction.

In an example, the handle is an integral part of the tray formed by the cutout.

In an alternative example, the cargo support further includes the handle, the handle being a separate component from the tray and being fastened to the tray at a perimeter of the cutout of the tray.

In an example, the handle fastened to the tray includes an upper handle fixture, at least a part of an interior side of which is over and faces a part of the top face of the tray, and a lower handle fixture, at least a part of an interior side of which is under and faces a part of the bottom face of the tray. Further, (a) the interior side of the upper handle fixture and/or (b) the interior side of the lower handle fixture includes a respective plurality of bosses extending from a base section of the respective fixture towards the other of the fixtures, thereby ensuring a predefined minimum vertical distance between an exterior face of the upper handle fixture and an exterior face of the lower handle fixture.

In an example, each of the interior side of the upper handle fixture and the interior side of the lower handle fixture includes the respective plurality of bosses.

In an example, each boss of at least a subset of the bosses includes a bore through which a respective fastener extends to fasten to the upper and lower handle fixtures to each other and to the tray. In an example, the tray includes a plurality of throughholes and each of the at least the subset of the bosses is positioned at least partly within a respective one of the throughholes, with a respective one of the fasteners of the respective boss extending through the respective throughhole. In an example, the respective radii of the at least the subset of the bosses and the radii of the respective throughholes within which the at least the subset of the bosses are positioned are dimensioned so that there is a friction fit connection between the at least the subset of the bosses and the respective throughholes within which the at least the subset of the bosses are positioned.

In an example, at least a region of the tray having the part of the top face of the tray over which the at least the part of the interior side of the upper handle fixture is positioned and having the part of the bottom face of the tray under which the at least the part of the interior side of the lower handle fixture is positioned is formed of wood, plastic, fiberglass, or other composite material, and the upper and lower handle fixtures are made at least partially of plastic or cast metal, e.g., cast aluminum. In an example, the parts of the handle are made of cast aluminum in a plastic surround.

In an example, the handle includes a housing and a latch control, at least a part of the latch control being slidable in the expansion and retraction directions within the housing and relative to the housing and the tray. In an example, the housing includes an upper handle fixture, at least a part of an interior side of which is over and faces a part of the top face of the tray, and a lower handle fixture, at least a part of an interior side of which is under and faces a part of the bottom face of the tray. In an example, (a) the interior side of the upper handle fixture and/or (b) the interior side of the lower handle fixture includes a respective plurality of bosses extending from a base section of the respective fixture towards the other of the fixtures, thereby ensuring a predefined minimum vertical void within the housing for accommodating the at least the part of the latch control within the housing.

In an example, when the tray is in any of at least a subset of positions relative to the base frame, the latch control (I) when shifted relative to the housing in the expansion direction, transitions the cargo support from (a) a locked state in which the longitudinal sliding of the tray relative to the base frame in the expansion and retraction directions is prevented into (b) an unlocked state in which the tray is slidable relative to the base frame in the expansion and retraction directions, and (II) when shifted relative to the housing in the retraction direction, transitions the cargo support from the unlocked state into the locked state.

In an example, along an entire length of at least a portion of a surface of the latch control that faces towards the first side of the tray, the surface of the latch control has a semicircular cross-section.

According to an example embodiment of the present invention, a cargo support includes: a tray; a first tray rail that is coupled directly or indirectly to a bottom face of the tray; a second tray rail that is coupled directly or indirectly to the bottom face of the tray and that extends longitudinally and parallel to the first tray rail; a base frame that includes a first base rail and a second base rail that extend longitudinally and parallel to each other; and a latch arrangement. The base frame includes bores via which the base frame is fastenable to a flatbed floor of a vehicle. The first and second tray rails are slidable relative to the first and second base rails, respectively, so that the tray is longitudinally slidable relative to the base frame (a) in an expansion direction from a retracted state of the cargo support to one or more expanded states of the cargo support and (b) in a retraction direction from any of the one or more expanded states to the retracted state. The first base rail includes a plurality of bores in a sidewall of the first base rail that faces the second base rail. The latch arrangement includes: a latch whose longitudinal position relative to the first and second tray rails is fixed and that is, at different times, insertable into, and removable from, each of the plurality of latch catch bores in the sidewall of the first base frame; a latch control; and a cord that extends from the latch control to the latch. The latch control is manually shiftable in the expansion direction and in the retraction direction. The shifting of the latch control in the expansion direction causes the cord to pull the latch away from the first base rail, to, when the latch is inserted in any of the plurality of latch catch bores in the sidewall of the first base frame, transition the cargo support from (a) a locked state in which the longitudinal sliding of the tray relative to the base frame in the expansion and retraction directions is prevented into (b) an unlocked state in which the tray is slidable relative to the base frame in the expansion and retraction directions. The shifting of the latch control in the retraction direction causes the cord to shift and, when the latch is aligned with any respective one of the plurality of latch catch bores in the sidewall of the first base frame, release the latch to shift into the respective one of the plurality of latch catch bores in the sidewall of the first base frame, thereby transitioning the cargo support from the unlocked locked state into the locked state. In an alternative example embodiment, the latch catch bores are in a sidewall of a component of the base frame other than any of the base rails. For example, the base frame can have another longitudinally extending bracket having the latch catch bores.

Although the latch control is described herein as being arranged for shifting in the expansion and retraction directions for pulling the cord in a manner by which the latch is controlled to shift laterally towards or away from the latch catch bores, in an alternative example embodiment, the latch controller can be structured and arranged to shift in other directions, e.g., in opposite lateral directions.

In an example, the latch arrangement further includes a spring that biases the latch toward the base rail. In an example, the spring applies an expansion force against a flange of the latch or against a component connected to the latch. In an example, the spring is a helical spring through which a portion of the latch extends. In an example, the spring applies an expansion force against a retaining surface that is connected to or is part of the latch. For example, in an example embodiment, the retaining surface is formed by a cotter pin that is inserted through the latch. In an alternative example embodiment, the retaining surface is a radially extending lip that is an integral part of the latch.

In an example, the cargo support includes a handle that includes a housing fixed to the tray and a latch controller. A part of the latch controller is arranged inside the housing and is shiftable inside the housing in the expansion and retraction directions. The latch controller includes a tongue that (i) extends from inside the housing to outside of the housing in the retraction direction and (ii) is connected to the cord, so that a pulling of the latch controller relative to the housing in the expansion direction causes the cord to pull the latch away from the first base rail.

According to an example embodiment of the present invention, a cargo support includes: a tray; a first tray rail that extends longitudinally and is coupled directly or indirectly to a bottom face of the tray; a second tray rail that extends longitudinally and is coupled directly or indirectly to the bottom face of the tray; a base frame that includes a first base rail and a second base rail that extend longitudinally; a first roller that is attached to, and laterally extends across, the first base rail; and a second roller that is attached to, and laterally extends across, the second base rail. Each of the first and second rollers includes (a) laterally exterior sections and (b) a tubular laterally interior section extending laterally between the exterior sections. The exterior sections and the interior section are all concentrically aligned along a common axis. The interior section is radially smaller than the exterior sections, so that there are respective radial steps at respective transitions from each of the exterior sections to the interior section, thereby forming a circumferential groove. A bottom of the first tray rail is supported, in the groove of the first roller, by a top of the interior section of the first roller. A bottom of the second tray rail is supported, in the groove of the second roller, by a top of the interior section of the second roller. A difference between a width of the groove of the first roller to a width of a region of the first tray rail that is supported by the top of the interior section of the first roller is greater than a difference between a width of the groove of the second roller to a width of a region of the second tray rail that is supported by the top of the interior section of the first roller. The first and second tray rails are slidable relative to the first and second base rails, respectively, with a corresponding spinning of the first and second rollers, so that the tray is longitudinally slidable relative to the base frame (a) in an expansion direction from a retracted state of the cargo support to one or more expanded states of the cargo support and (b) in a retraction direction from any of the one or more expanded states to the retracted state.

According to an example embodiment of the present invention, a cargo support includes: a tray; a first tray rail that extends longitudinally and is coupled directly or indirectly to a bottom face of the tray; a second tray rail that extends longitudinally and is coupled directly or indirectly to the bottom face of the tray; a base frame that includes a first base rail and a second base rail that extend longitudinally; a first roller that is attached to, and laterally extends across, the first base rail and that supports a bottom of the first tray rail; and a second roller that is attached to, and laterally extends across, the second base rail and that supports a bottom of the second tray rail. The first and second tray rails are slidable relative to the first and second base rails, respectively, with a corresponding spinning of the first and second rollers, so that the tray is longitudinally slidable relative to the base frame (a) in an expansion direction from a retracted state of the cargo support to one or more expanded states of the cargo support and (b) in a retraction direction from any of the one or more expanded states to the retracted state. Each respective one of the first and second base rails includes (a) a first pair of bores in respective sidewalls of the base rail that share a same vertical coordinate and a same longitudinal coordinate as each other and (b) a second pair of bores in respective sidewalls of the base rail that (i) share a same vertical coordinate and a same longitudinal coordinate as each other and (ii) are vertically and laterally shifted from the first pair of bores. The first roller and the first and second bores of the first base rail are structured such that the attachment of the first roller to the first base rail can alternatively (a) be made at, and using, the first pair of bores of the first base rail and (b) be made at, and using, the second pair of bores of the first base rail. The first roller and the first and second bores of the second base rail are structured such that the attachment of the second roller to the second base rail can alternatively (a) be made at, and using, the first pair of bores of the second base rail and (b) be made at, and using, the second pair of bores of the second base rail. A vertical distance of an end of the tray, which is longitudinally shifted away from the base frame when the tray is longitudinally slid relative to the base frame in the expansion direction, from a bottom of the base frame differs depending on at which of the first and second pairs of bores the first and second rollers are attached to the first and second base rails.

According to an example embodiment of the present invention, cargo supports are structured so that different cargo supports rated for different maximum weights can be assembled using predominantly the same parts, with just minor changes with respect to the size of tray rails and with respect to whether to install stiffeners. Therefore, in an example, a pair of cargo supports that are installable on a flatbed floor of a vehicle include a first cargo support and a second cargo support. Each respective one of the cargo support includes: a respective tray; a respective first tray rail that is coupled directly or indirectly to a bottom face of the respective tray; a respective second tray rail that is coupled directly or indirectly to the bottom face of the respective tray and that extends longitudinally and parallel to the respective first tray rail; and a respective base frame that is attachable to the flatbed floor and includes a respective first base rail and a respective second base rail that extend longitudinally and parallel to each other. The first and second tray rails of the respective cargo support are slidable relative to, respectively, the first and second base rails of the respective cargo support, so that the respective tray is longitudinally slidable relative to the respective base frame (a) in an expansion direction from a retracted state of the respective cargo support to one or more expanded states of the respective cargo support and (b) in a retraction direction from any of the one or more expanded states to the retracted state. The first cargo support, and not the second cargo support, includes, for each of the respective first and second base rails a respective stiffener attached to the respective first and second base rails.

In an example, other than that the first cargo support, and not the second cargo support, includes the respective stiffeners, the first and second cargo supports are structured the same as each other except that (I) a height of the first and second rails of the first cargo support in at least one longitudinal section of the first and second rails of the first cargo support is greater than a height of the first and second rails of the second cargo support in at least one longitudinal section of the first and second rails of the second cargo support that corresponds to the at least one longitudinal section of the first and second rails of the first cargo support; and/or (II) a distance of extension of the tray rails in the expansion direction beyond a support of the base rails on which the tray rails roll is greater in the first cargo support than in the second cargo support. These differences can allow for different weight capacities, with the stiffeners being provided in the cargo support having the higher weight capacity.

In an example, the first cargo support is rated for carrying cargo of up to 1,000 pounds, and the second cargo support is rated for carrying cargo of up to and no more than 600 pounds.

In an example, the height of the first and second rails of the first cargo support in the at least one longitudinal section of the first and second rails of the first cargo support is 2 inches, and the height of the first and second rails of the second cargo support in the at least one longitudinal section of the first and second rails of the second cargo support is 1.5 inches. In an example, the at least one longitudinal section of each of the first and second rails of each of the first and second cargo supports has a width of 1.5 inches.

In an example, each of the stiffeners is welded to the respective base rail to which the respective stiffener is attached.

In an example, each of the first and second cargo supports includes a respective stop pin that extends laterally within each of the first and second base rails. With respect to each of the first and second tray rails of each of the first and second cargo supports, at least one respective flange extends vertically downward below a bottom of the at least one longitudinal section of the respective tray rail to at least as low as vertical coordinate of at least part of stop pin of a respective one of the base rails, the stop pins thereby limiting a degree by which the respective trays are longitudinally slidable relative to the respective base frames. With respect to each of the first and second base rails of the first cargo support, at least a part of the respective stiffener that is attached to the respective base rail extends longitudinally from a longitudinal coordinate that is adjacent to a longitudinal coordinate of the respective stop pin of the respective base rail along at least part of the respective base rail in which the at least one respective flange of a respective one of the tray rails is slidable.

In an example, each of the stiffeners is notched at a bottom corner of the respective stiffener at an edge of the respective stiffener that is located at the respective stop pin of the respective base rail on to which the respective stiffener is attached, the notch having a shape that corresponds to a contour of a section of the respective stop pin that is outside of the respective base rail.

In an example, with respect to each of the tray rails, a respective tray rail roller (a) extends laterally through the at least one flange of the respective tray rail and (b) rolls within a respective one of the base rails at least partly below laterally extending lips of the respective one of the base rails when the respective tray of the respective cargo support is longitudinally slid relative to the respective base frame of the respective cargo support in the expansion and retraction directions.

According to an example embodiment of the present invention, a kit is provided for simple assembly of cargo supports that have different lengths. The kit facilitates assembly of a plurality of cargo supports that are installable on a flatbed floor of a vehicle. Each of the cargo supports includes a respective tray selected from a plurality of trays, respective tray rails that are selected from a plurality of tray rails and that are coupled directly or indirectly to a bottom face of the respective tray to extend in a longitudinal direction, and a respective base frame that includes, corresponding to each of the tray rails, a respective base rail selected from a plurality of base rails and installed so that the respective base rail extends in the longitudinal direction. The tray rails of the respective cargo support are slidable relative to, respectively, the corresponding ones of the base rails so that the respective tray is longitudinally slidable relative to the respective base frame (a) in an expansion direction from a retracted state of the respective cargo support to one or more expanded states of the respective cargo support and (b) in a retraction direction from any of the one or more expanded states to the retracted state. The plurality of cargo supports include at least a first one or more cargo supports and a second one or more cargo supports. The first one or more cargo supports differ from the second one or more cargo supports with respect to a respective length of the respective cargo supports in the longitudinal direction.

The kit includes the plurality of trays. The plurality of trays include one or more first trays that have a first tray length from which respective trays are selectable for assembly of the first one or more cargo supports and one or more second trays that have a second tray length different than the first tray length and from which respective trays are selectable for assembly of the second one or more cargo supports.

The kit includes the plurality of tray rails. The plurality of tray rails include one or more first tray rails that have a first tray rail length from which respective tray rails are selectable for assembly of the first one or more cargo supports and one or more second tray rails that have a second tray rail length different than the first tray rail length and from which respective tray rails are selectable for assembly of the second one or more cargo supports.

The kit includes the plurality of base rails. The plurality of base rails include one or more first base rails that have a first base rail length from which respective base rails are selectable for assembly of the first one or more cargo supports and one or more second base rails that have a second base rail length different than the first base rail length and from which respective base rails are selectable for assembly of the second one or more cargo supports.

The kit includes a plurality of latch control cords. The plurality of latch control cords include one or more first latch control cords that have a first cord length from which respective latch control cords are selectable for assembly of the first one or more cargo supports and one or more second latch control cords that have a second cord length different than the first cord length and from which respective latch control cords are selectable for assembly of the second one or more cargo supports.

The kit includes a plurality of handles. Each of the handles is alternatively selectable for installation on the trays of each of the first one or more cargo supports and the second one or more cargo supports. When installed, the respectively installed handle is connected to a respectively installed one of the latch control cords.

The kit includes a plurality of latches. Each of the latches is alternatively selectable for connection to the latch control cords of each of the first one or more cargo supports and the second one or more cargo supports. When installed, the respectively installed latch is insertable and removable from one of the respectively installed base rails by longitudinal shifting of at least a part of the respectively installed handle.

The kit includes a plurality of springs. Each of the springs is alternatively selectable for installation to apply a biasing force to the respectively installed latches of each of the first one or more cargo supports and the second one or more cargo supports.

The kit includes a plurality of base rollers. Each of the base rollers is alternatively selectable for attachment to respective ones of the base rails of each of the first one or more cargo supports and the second one or more cargo supports.

The kit includes a plurality of stop pins that are each alternatively selectable for attachment to respective ones of the base rails of each of the first one or more cargo supports and the second one or more cargo supports. The stop pins, when installed, limit a degree to which the respective trays are extendable in the expansion direction.

The kit includes a plurality of tray rail rollers, each being alternatively selectable for (a) attachment to respective ones of the tray rails of each of the first one or more cargo supports and the second one or more cargo supports and (b) installation within respective ones of the base rails of each of the first one or more cargo supports and the second one or more cargo supports.

In an example, the kit further includes a plurality of tray frame components including a plurality of corner components, a plurality of laterally extending components, and a plurality of longitudinally extending components, where each of the corner components and each of the laterally extending components are alternatively selectable for installation on any of the frames of any of the first one or more cargo supports and the second one or more cargo supports. The longitudinally extending components include a first subset of the longitudinally extending components and a second subset of the longitudinally extending components. The first subset is usable for selection of parts for construction of the tray frames of the first one or more cargo supports, and the second subset is usable for selection of parts for construction of the tray frames of the second one or more cargo supports.

### BRIEF DESCRIPTION OF THE FIGURES

FIGS. 1 and 2 show a conventional cargo support installed on a flatbed floor of a truck in a retracted state and in an expanded state.

FIG. 3 shows a topside perspective view of a cargo support according to an example embodiment of the present invention.

FIG. 4 shows a tray roller attached to a tailgate end of a tray rail stop bracket of a tray rail.

FIG. 5 is a partial underside perspective of a cargo support in a retracted position showing part of a cable sheath and spring cable extending from a handle, according to an example embodiment of the present invention.

FIG. 6 shows a base rail with a right pin stop, with a base roller attached to a tailgate end of the base rail and with a tray roller arranged within the base rail, according to an example embodiment of the present invention.

FIG. 7 shows another view of the base rail and the pin stop, according to an example embodiment of the present invention.

FIG. 8 shows the tray rail over the base roller, but without showing the base rail to show the function of the pin stop in limiting extension of the cargo support, according to an example embodiment of the present invention.

FIGS. 9 and 10 show views of a frame section of the cargo support without showing the tray, according to an example embodiment of the present invention.

FIG. 11 shows left and right sections of the cargo support in a view from the tailgate side towards the cab-side, with a laterally central region removed, to show a difference between a ratio of the grooves of left and right rollers to the widths of the tray rails (at least in instances in which the left and right tray rails have a same width as each other), according to an example embodiment of the present invention.

FIGS. 12 and 13 provide magnified views of the left and right sections of FIG. 11, according to an example embodiment of the present invention.

FIGS. 14 and 15 show different perspectives of the base rail according to an example embodiment of the present invention.

FIG. 16 is a perspective top view of a portion of the cargo support, showing a top of the tray and the handle, according to an example embodiment of the present invention.

FIG. 17 is an exploded view of the handle according to an example embodiment of the present invention.

FIG. 18 shows the top handle plate, the bottom handle plate, and the latch controller in their assembled state, but in a view without the tray, according to an example embodiment of the present invention.

FIG. 19 shows a top view of the top handle plate, according to an example embodiment of the present invention.

FIG. 20 shows a bottom view of the top handle plate, according to an example embodiment of the present invention.

FIG. 21 shows a bottom view of the bottom handle plate, according to an example embodiment of the present invention.

FIG. 22 shows a top view of the bottom handle plate, according to an example embodiment of the present invention.

FIG. 23 provides an exploded view of the handle relative to the tray, according to an example embodiment of the present invention.

FIG. 24 provides a perspective view of an underside of the cargo support, showing a cable holder tongue exiting from a housing part of the handle to a region under the tray, according to an example embodiment of the present invention.

FIGS. 25 and 26 show, respectively, top and bottom views of a latch controller part of the handle, according to an example embodiment of the present invention.

FIG. 27 provides a perspective view of the latch controller with a spring cable connected to the cable holder tongue, according to an example embodiment of the present invention.

FIG. 28 shows a bottom perspective view of a portion of the cargo support, showing the cable curving to a locking mechanism, according to an example embodiment of the present invention.

FIGS. 29 and 30 show details of the locking mechanism according to an example embodiment of the present invention.

FIG. 31 shows rotational forces generated by the weight of cargo on the cargo support, when the cargo support is installed on a flatbed floor of a truck and is in an expanded state, according to an example embodiment of the present invention.

FIG. 32 shows rotational forces of the tray rail roller against the base rail, for example, when the cargo support is in the state shown in FIG. 31, according to an example embodiment of the present invention.

FIG. 33 shows a stiffener according to an example embodiment of the present invention.

FIG. 34 provides an exploded and transparent view of a tray and a tray frame, according to an example embodiment of the present invention.

FIG. 35 shows an underside of the cargo support when extended to its maximum expanded position, showing an installation of the cable and cable sheath according to an example embodiment of the present invention.

FIG. 36 shows a chamfered edge of a latch according to an example embodiment of the present invention.

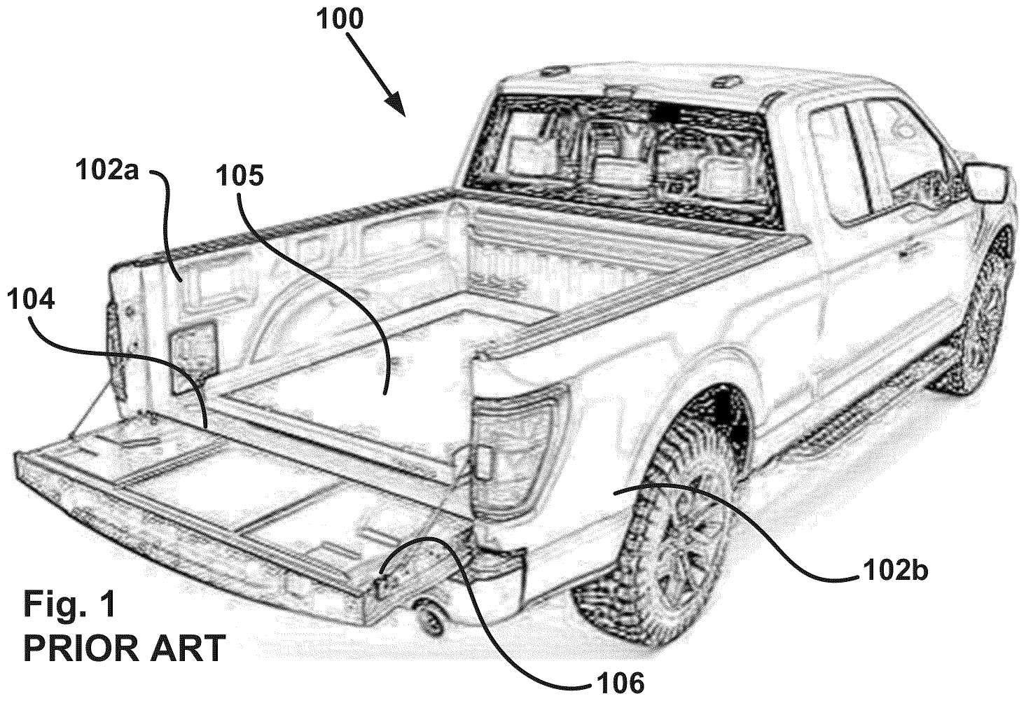

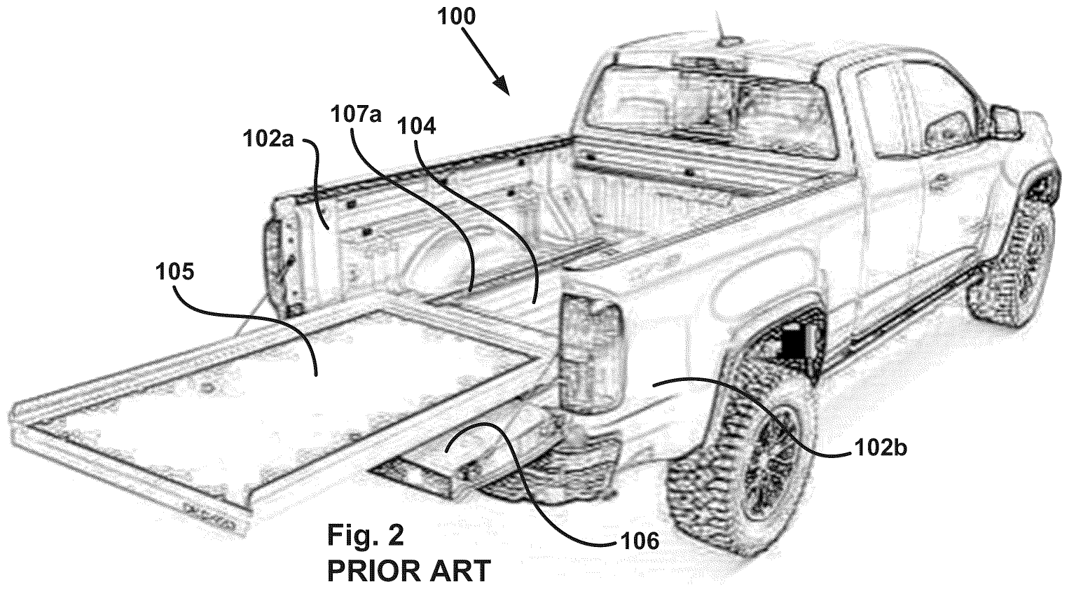

### DETAILED DESCRIPTION

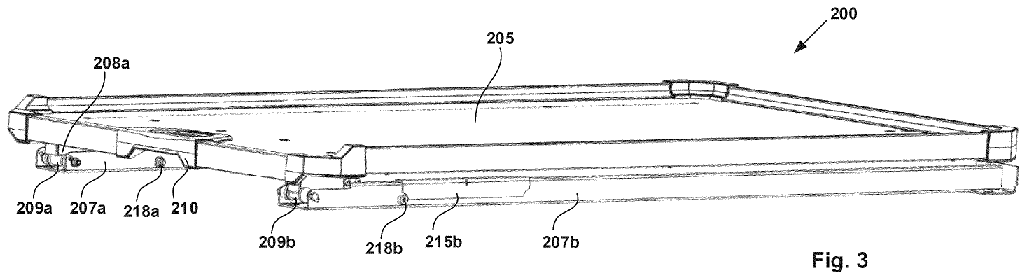

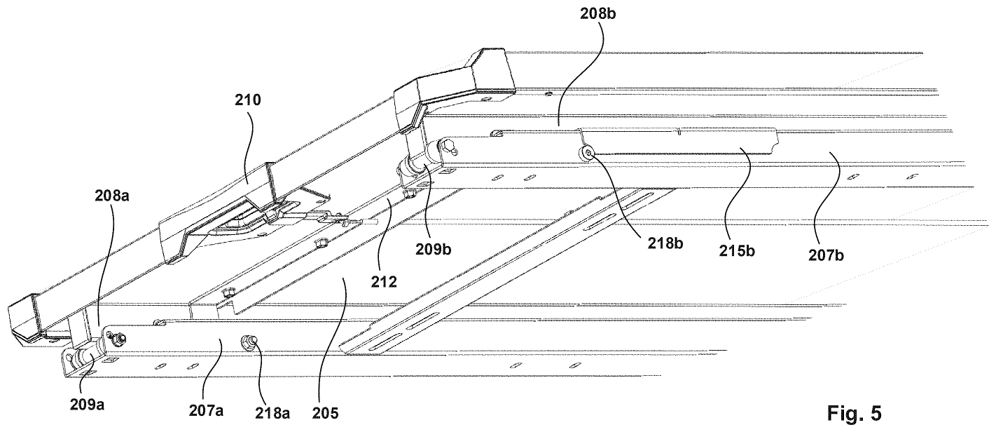

FIG. 3 shows a topside perspective view of a cargo support 200 that includes a tray 205 to which a left tray rail 208a, a right tray rail 208b, and a handle 210 are attached. FIG. 5 shows an example underside of the cargo support 200. (In the description presented herein, right and left are to be understood according to a view of the cargo support 200 from the tailgate side.) The cargo support 200 further includes a left base rail 207a and a right base rail 207b, which are structured for being fastened to a flatbed floor of a truck. For example, the left base rail 207a and the right base rail 207b include bores through which screws or the like can be inserted for being screwed into the flatbed floor. A left roller 209a is fastened to the left base rail 207a, and a right roller 209b is fastened to the right base rail 207b.

The tray 205 can be rolled for expansion in the longitudinal direction from a cab-side of the cargo support 200 (the side proximal to the passenger cabin of the truck) towards a tailgate side of the cargo support 200 by a user pulling on the handle 210 with a force that is towards the tailgate side, and for retraction in the longitudinal direction from the tailgate side towards the cab-side, for example, by the user pushing against the handle 210 with a force towards the cab-side. For the rolling of the tray 205, the cargo support 200 is configured for the tray rails 208a and 208b to be slide in the longitudinal directions relative to the base rails 207a and 207b, respectively, while the base rails 207a and 207b remain stationary to the flatbed floor.

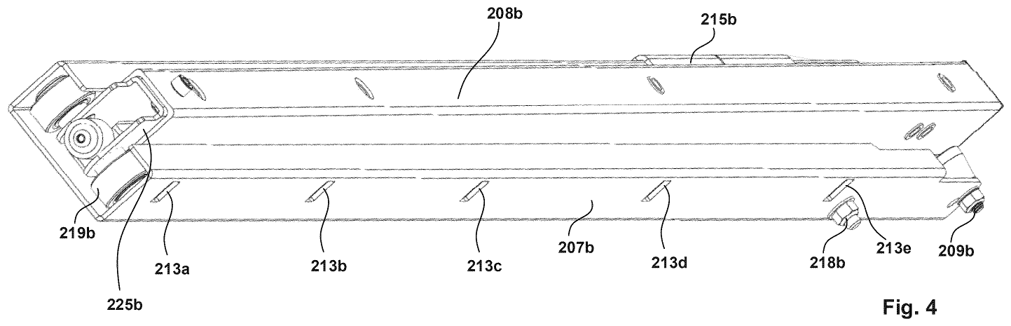

In an example embodiment, for the relative sliding of the tray rails 208a and 208b relative to the base rails 207a and 207b, the rollers 209a and 209b are configured to roll and support the bottoms of respective ones of the tray rails 208a and 208b. In an example embodiment, for the relative sliding of the tray rails 208a and 208b relative to the base rails 207a and 207b, respective tray rollers are attached to the tray rails 208a and 208b. For example, FIG. 4 shows a right tray roller 219b attached to a tailgate end of a right tray rail stop bracket 225b, the right tray rail stop bracket 225b being held within and attached to the right tray rail 208b. (Although not shown, it is understood that the left side of the cargo support 200 can have such a structure as well. In fact, in an example embodiment, the descriptions provided below regarding the right side of the cargo support 200 and the illustrations of the right side of the cargo support 200 shown in the figures can be mirrored at the left side of the cargo support 200, but whereas components at the right side, which are mirrored by like components at the left side, have legends ending with the letter ‘b’, the mirrored components at the left side have the same legend number but end with the letter ‘a’). The right tray roller 219b rolls within the right base rail 207b (and the left tray roller rolls within the left base rail 207a).

Although FIGS. 3, 5, 28, and 35 show the tray rails 208a-b fastened directly to the underside of the tray 205, in an alternative example embodiment, the illustrated tray rails 208a-b are provided as intermediate rails between the base rails 207a-b and still further rails that are fastened to the underside of the tray 205. Such an alternative configuration increases the degree to which the cargo support 200 can be extended in the expansion direction. By providing such an alternative three-tiered rail system, the intermediate rails 208a-b can partially overlap the base rails 207a-b, while the upper rails (not shown) partially overlap the intermediate rails 208a-b, so that the upper rails, which are fastened to the underside of the tray 205, can be slip to a position at which they are completely clear of, and do not vertically overlap, the base rails 207a-b.

In an example embodiment, the base rails 207a and 207b are each structured as a c-channel, with a base attached to the flatbed floor of the truck, two sidewalls extending vertically away from the flatbed floor, and two lips, each extending laterally from the tops of respective ones of the sidewalls of the c-channel towards each other, but not reaching each other, so that the ray rail 208a/208b can extend vertically from within the c-channel to a point above the c-channel. The wheels of the tray roller 219b roll within the c-channel under respective ones of the lips. Thus, while the tray roller 219b attached at the tailgate end of the tray rail 208b rolls within the base rail 207b, at least a portion of the region of the tray rail 208b that is at the tailgate side of the tray roller 219b can be slid over the roller 209b attached to the base rail 207b.

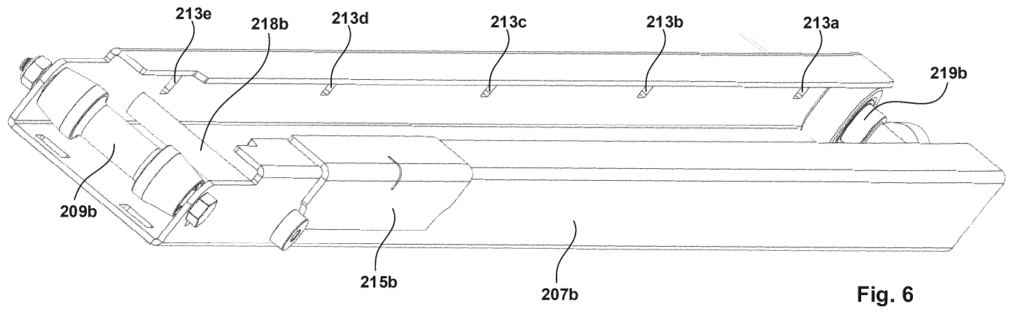

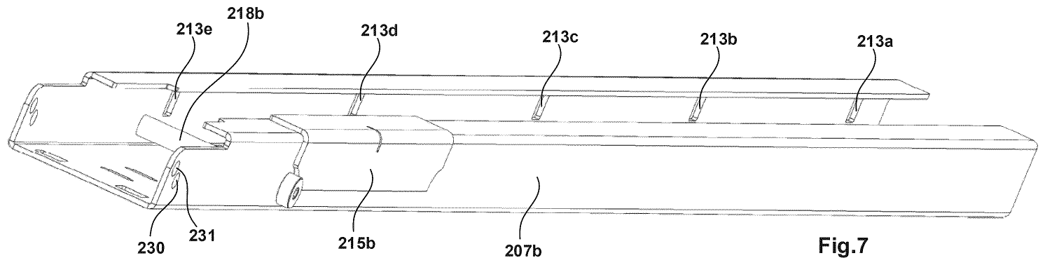

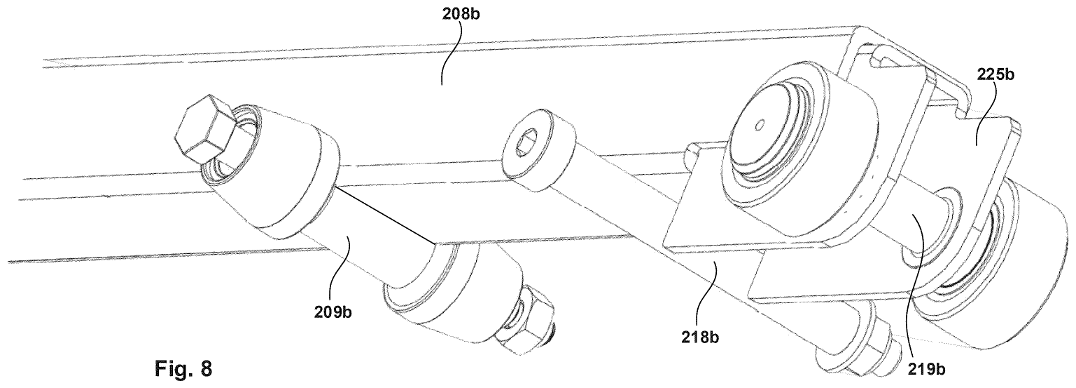

FIG. 6 shows an example embodiment of the base rail 207b with a right pin stop 218b attached to, and extending laterally through, the base rail 207b, with the roller 209b attached to the tailgate end of the base rail 207b and with the tray roller 219b (whose attachment to tray rail 208b is not shown in order not to obscure the view of the components illustrated in the figure). FIG. 7 shows another view of the base rail 207b and the right pin stop 218b. The right pin stop 218b (and the left pin stop, which is not shown and is at the left base rail 207a) limits the degree to which the tray 205 can be extended in the tailgate direction relative to the base rails 207a and 207b. In order to show the way this limitation is implemented, FIG. 8 shows the right tray rail 208b over the right roller 209b, which is attached to the right base rail 207b, without showing the right base rail 207b. As shown in FIG. 8, in an example embodiment, the right tray rail stop bracket 225b includes a bottom section that extends downward beyond a bottom of the right tray rail 208b. Therefore, when the right tray rail 208b is extended to its most predefined expanded position, the tailgate edge of the bottom section of the right tray rail stop bracket 225b abuts against the cargo-side of the right pin stop 218b, preventing further sliding of the tray 205 in the tailgate direction.

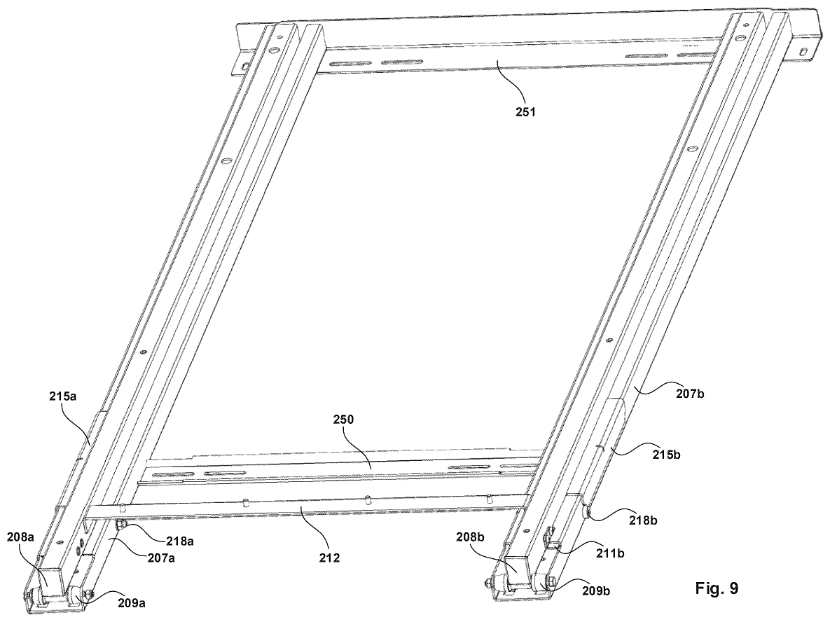

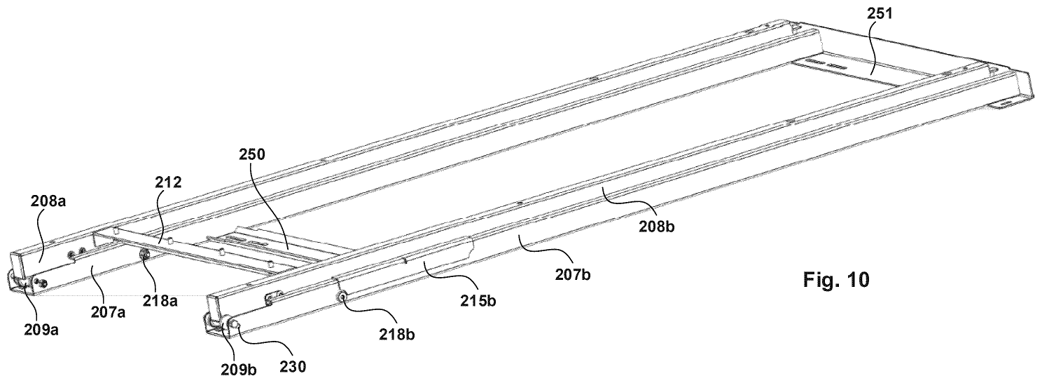

FIG. 9 and FIG. 10 show views of a frame section of the cargo support 200 without the tray 205, according to an example embodiment of the present invention. As shown in FIGS. 9 and 10, the cargo support 200 includes a tailgate side lateral tray support 212, which is fastened to an underside of the tray 205. In the illustrated example, the tray support 212 includes vertically extending flanges at the two lateral ends of the tray support 212 which abut against inner side walls of the left and right tray rails 207a and 207b in order to provide squaring support for maintain correct parallel positioning of the tray rails 207a and 207b relative to each other. In the illustrated example, the cargo support 200 further includes a tailgate lateral base support 250 and a cab-side lateral base rail support 251 for squaring the base rails 207a and 207b relative to each other.

As shown in FIG. 9, in an example embodiment, a tray rail lift stop 211b is attached to the tray rail 208b. The tray rail lift stop 211b prevents a lift of the tray rail 208b upwards away from the base rail 207b when the tray 205 is in the retracted position, because one of the lips of the ‘c’ of the c-channel structure of the base rail 207b extends over a laterally extending section of the tray rail lift stop 211b when the tray 205 is in the retracted position.

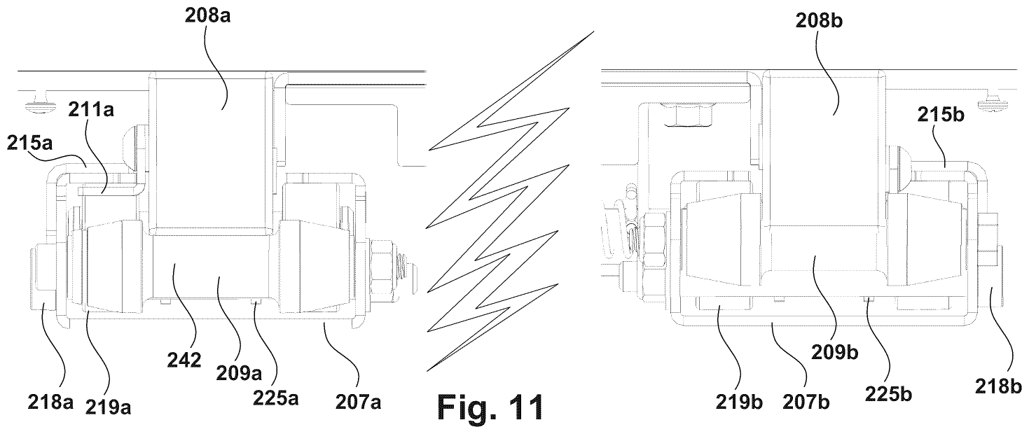

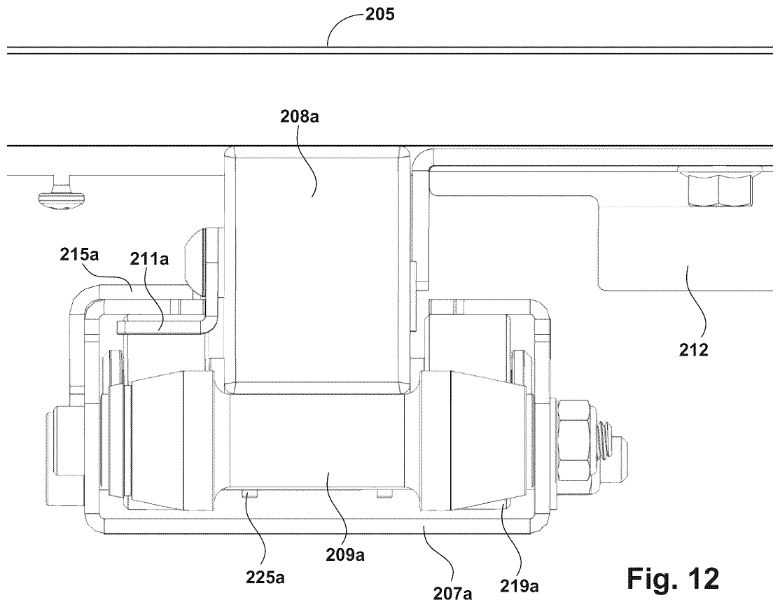

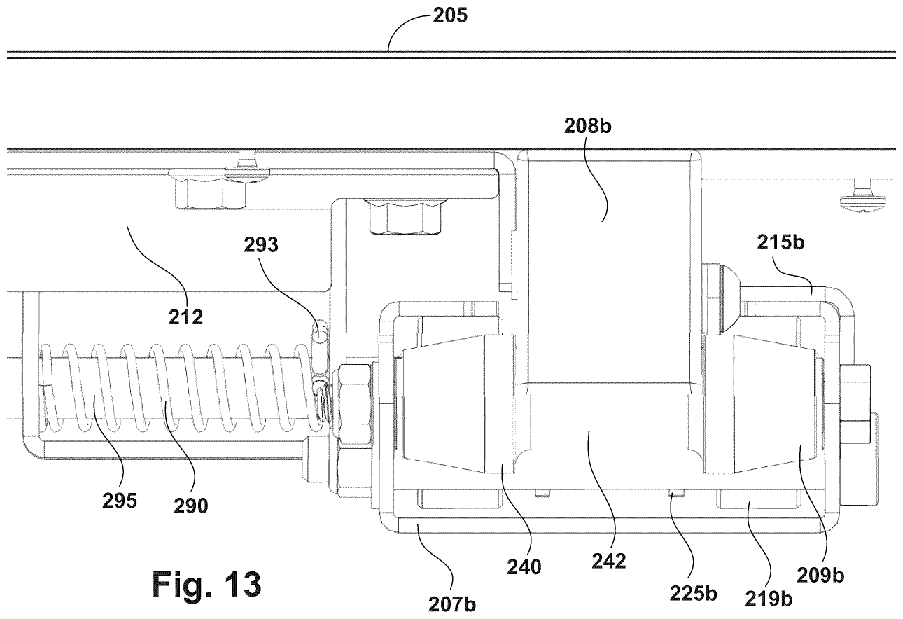

FIG. 11 shows left and right sections of the cargo support 200, with a laterally central region removed, in order to be able to show the left and right sections near each other for comparison, according to an example embodiment of the present invention. FIG. 12 provides a magnified view of the left section of FIG. 11 and FIG. 13 provides a magnified view of the right section of FIG. 11. The rollers 209a and 209b each includes an interior region 242 extending between laterally surrounding parts of an exterior region 240, with a radial step between the exterior and interior regions 240 and 242, so that, over an entire circumference of the respective roller 209a/209b, the exterior region is 240 has a greater radial extension than the interior region 242, with a lateral extension of the interior region 242 being wide enough to support a respective one of the tray rails 208a/208b on the interior region 242 between the surrounding parts of the exterior region 240.

In order for the tray 205 to be slid between the extended and retracted positions without laterally wobbling, it is advantageous for the width of the tray rail to be approximately equal to the width of the interior region 242, since the less distance there is from the exterior surfaces of the sidewalls of the tray rail to the interiorly facing surfaces of the exterior region 240, the less the tray can laterally wobble.

However, as is apparent from FIGS. 11-13, in an example embodiment, the relative widths of the left tray rail 208a and of the interior region 242 of the left roller 209a to each other is different than the relative widths of the right tray rail 208b and of the interior region 242 of the right roller 209b to each other, so that there is a greater difference (a) between the width of one of the tray rails and the width of the interior region 242 of the roller on which the respective tray rail is supported than (b) between the width of the other one of the tray rails and the width of the interior region 242 of the roller on which the other respective tray rail is supported. For example, in the illustrated example embodiment, there is a greater distance from the exterior sidewalls of the left tray rail 208a from the interiorly facing surfaces of the exterior region 240 of the roller 209a than from the exterior sidewalls of the right tray rail 208b from the interiorly facing surfaces of the exterior region 240 of the roller 209b. The side providing the tighter space for the tray rail provides good anti-wobble support. However, if both sides are structured this way, then this can cause a binding effect when sliding the tray 205 if the installation of the base rails 207a and 207b are sch that they are not sufficiently square to each other and/or if the installation of the tray rails 208a and 208b are not sufficiently square to each other. Therefore, according to an example embodiment, while one of the side provides the tight space of the interior region 142 for supporting therein a respective one of the tray rails for anti-wobble support, the other side provides a looser fit between the respective tray rail and the interior region 142 of the respective roller in order to provide greater tolerance for a misalignment between the left rails and the right rails relative to one another, so that, in case the rails are installed/manufactured not perfectly square relative to each other, the tray 205 can be expanded and retracted without binding.

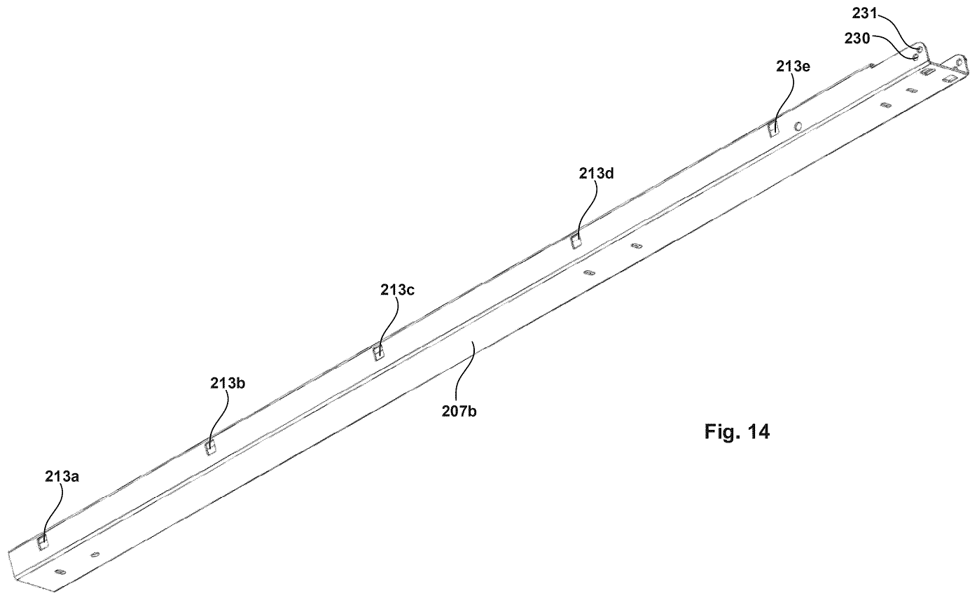

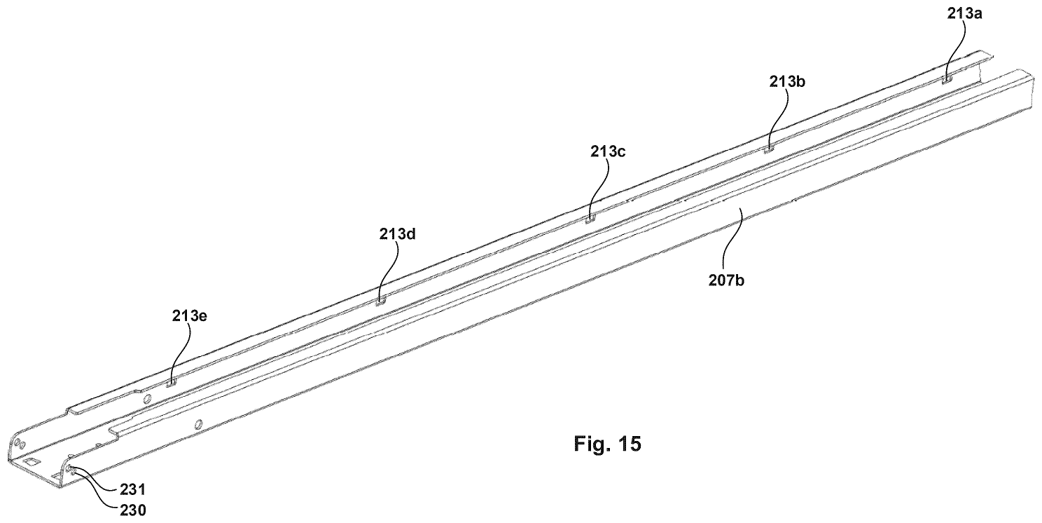

FIGS. 14 and 15 show the right base rail 207b from different perspectives, according to an example embodiment in which the right base rail 207b includes a first pair of roller support bores 230 and a second pair of roller support bores 231, where the right roller 209b can be fastened to the right base rail 207b alternatively either (a) at and via the first pair of roller support bores 230 or (b) at and via the second pair of roller support bores 231, wherein the first pair of roller support bores 230 is both horizontally and vertically offset from the second pair of roller support bores 231.

In this regard, tailgates of different trucks can be constructed differently than one another so that, when the respective tailgates are opened into their horizontal positions, the respective tops of the interior surface of the respective tailgate, which face upward in the horizontal position, can be at different distances from the respective trucks' respective flatbed floors. Therefore, in order for the bottom of the tray 205 and the bottoms of the tray rails 208a and 208b to be able to clear the top of the respective tailgates that are in their opened states, different distances are required between the bottoms of the tray rails 208a and 208b from the flatbed floor at the tailgate end of the cargo support 200. Less distance is necessary for installation in a truck with a low tailgate profile (in the opened state relative to the flatbed floor) than for installation in a truck with a higher tailgate profile. On the other hand, the lower the tray 205 can be installed relative to the flatbed floor the better. Therefore, where the tailgate profile permits, it is best to support the tray rails 208a and 208b at a low position, and to install the cargo support 200 with a greater distance of the tray rails 208a and 208b from the flatbed floor where necessary due to installation in a truck with a higher tailgate profile.

For this reason, in an example embodiment, the base rails 207a and 207b include both the first pair of roller support bores 230 and the second pair of roller support bores 231. When the cargo support 200 is installed in a truck having a tailgate with a low profile, the rollers 209a and 209b can be installed in the first pair of roller support bores 230, so that the rollers 209a and 209b support the tray rails 208a and 208b at the lower position. On the other hand, when the cargo support 200 is installed in a truck having a tailgate with a higher profile, the rollers 209a and 209b can be installed in the second pair of roller support bores 231, so that the rollers 209a and 209b support the tray rails 208a and 208b at the higher position, since the bottoms of the tray rails 208a and 208b would otherwise not clear the top of the upward facing interior faces of the tailgate if the rollers 209a and 209b were installed at the first pair of roller support bores 230.

Therefore, the first pair of roller support bores 230 and the second pair of roller support bores 231 are vertically offset from each other, with the first pair of roller support bores 230 being used when the cargo support 200 is installed in a truck having a tailgate that, when in its opened position, has a sufficiently low profile relative to the flatbed floor, and with the second pair of roller support bores 231 being used when the cargo support 200 is installed in a truck having a tailgate that, when in its opened position, has an insufficiently low profile relative to the flatbed floor to allow for the bottom of the tray rails 208a and 208b to clear over the upward facing face of the opened tailgate if the tray rails 208a and 208b are supported by the rollers 209a and 209b installed at the first pair of roller support bores 230.

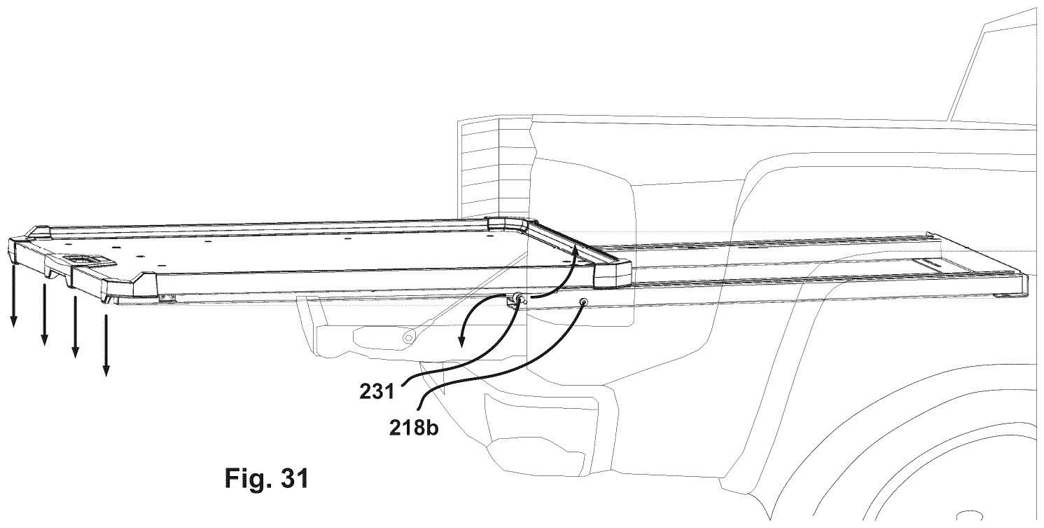

Additionally, as noted above, the first pair of roller support bores 230 and the second pair of roller support bores 231 are horizontally offset from each other, in order for the base rails 207a and 207b to have sufficient strength vertically immediately below the used one of the pairs of roller support bores 230/231 for supporting the weight of the installed rollers 209a/209b, the weight of the tray rails 208a/208b that slide over the installed rollers 209a/209b, the weight of the tray 205 to the underside of which the tray rails 208a/108b are attached, and the weight of cargo for which the cargo support 200 is rated. For example, in example embodiments, the cargo support 200 is rated for supporting cargo weighing up to 600 pounds and in other example embodiments, the cargo support 200 is rated for supporting cargo weighing up to 1,000 pounds. In other example embodiments, cargo supports 200 can be rated for other maximum weights. Additionally, the tray 205 carrying the cargo for which the cargo support 200 is rated is intended to be expanded in the expansion/tailgate direction. As shown in FIG. 31, when the cargo support 200 is in its fully extended state, the weight at the tailgate edge of the tray 205, especially when the cargo support 200 is loaded with the weight for which it is rated causes a downward force at the tailgate edge of the tray 205, with a region at which the rollers 209a/209b are located being a fulcrum, the point of rotation, to the tailgate side of which there is a downward force and to the cab-side of which there is an upward force. If the base rails 207a/207b have insufficient strength vertically below the positions of the rollers 209a/209b, to withstand the downward rotational force at the fulcrum, the rollers 209a/209b would collapse. If the first pair of roller support bores 230 would be positioned immediately vertically below the second pair of roller support bores 231, this would weaken the base rails 207a/207b are the fulcrum position of the second pair of roller support bores 231, rendering them unusable for supporting the rollers 209a/209b. Therefore, according to an example embodiment of the present invention, the first pair of roller support bores 230 and the second pair of roller support bores 231 are horizontally offset from each other, so that there is sufficient rail material under the second pair of support bores 231. In an example embodiment, the base rails 207a/207b are formed of a metal, e.g., steel.

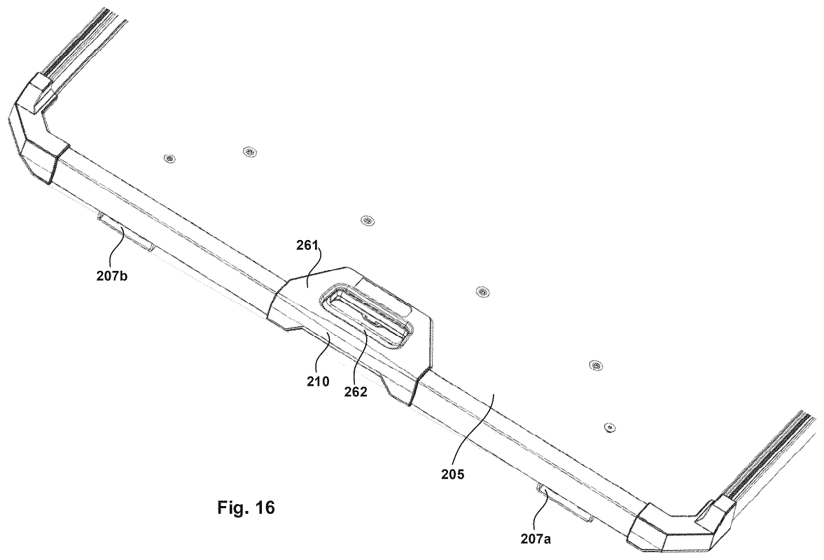

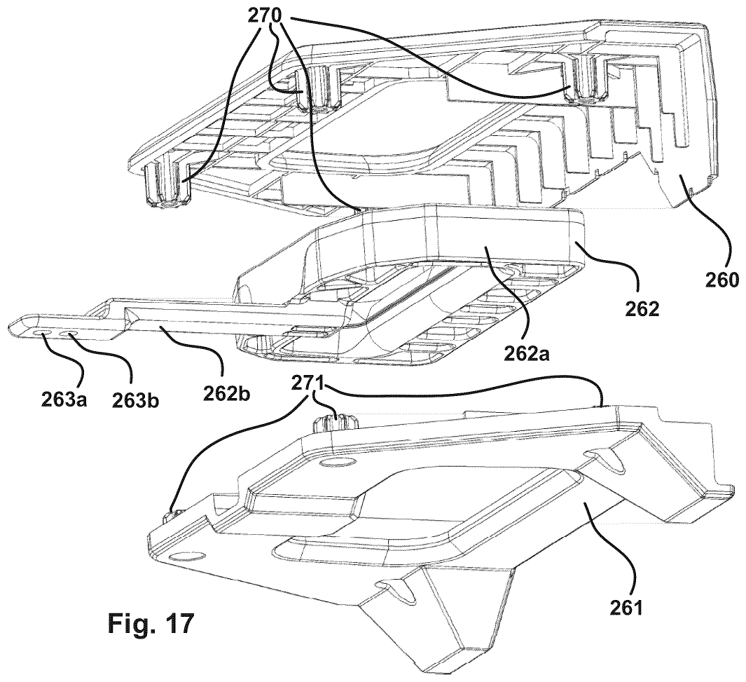

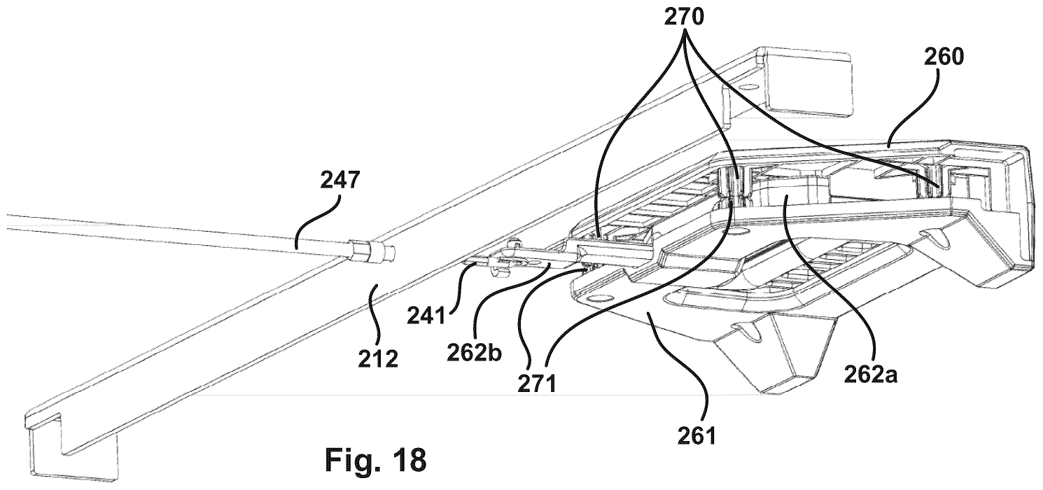

FIG. 16 is a perspective top view of a portion of the cargo support 200, showing a top of the tray 205 and showing the handle 210. FIG. 17 is an exploded view of the handle 210 according to an example embodiment of the present invention. In the illustrated example, the handle 210 includes a top handle plate 260, a bottom handle plate 261, and a latch controller 262, a portion of which is held between, and movably relative to, the top handle plate 260 and the bottom handle plate 261, the top handle plate 260 and bottom handle plate 261 forming a housing. The latch controller 261 includes a core 262a held between the top handle plate 260 and the bottom handle plate 261. The latch controller 261 also includes a cable holder tongue 262b attached to or integrally formed with the core 262a and that extends from within the housing formed by the top handle plate 260 and bottom handle plate 261 to outside of the housing. FIG. 18 shows the top handle plate 260, the bottom handle plate 261, and the latch controller 262 in their assembled state, showing the core 262a held within the housing formed by the top handle plate 260 and the bottom handle plate 261 and showing the cable holder tongue 262b extending from inside the housing to outside the housing. The core 262a can be shifted inside and relative to the housing in the extension and retraction directions. The cab-side end of the cable holder tongue 262b is connected to a cable 241, a portion of which is held within a cable sheath 247, so that the shifting of the core 262a in the extension and retraction directions causes a corresponding shifting of a tailgate end of the cable 241 in the extension and retraction directions.

The cable 241 may stretch and loosen over time, reducing the ability of the cable 241 to properly control a latch 295 (described below). Therefore, according to an example embodiment of the present invention, the cab-side end of the cable holder tongue 262b includes a plurality, e.g., two, bores, for example bores 263a and 263b shown in FIG. 17 to which the cable 241 can be alternatively connected. For example, at a time of initial installation, the cable 241 can be connected to the cable holder tongue 262b using the cab-side bore 263a, and after some time, if the cable 241 stretches, the tailgate end of the cable 241 can be removed from bore 263a and connected to bore 263b, this is arranged further towards the tailgate end of the cargo support 200.

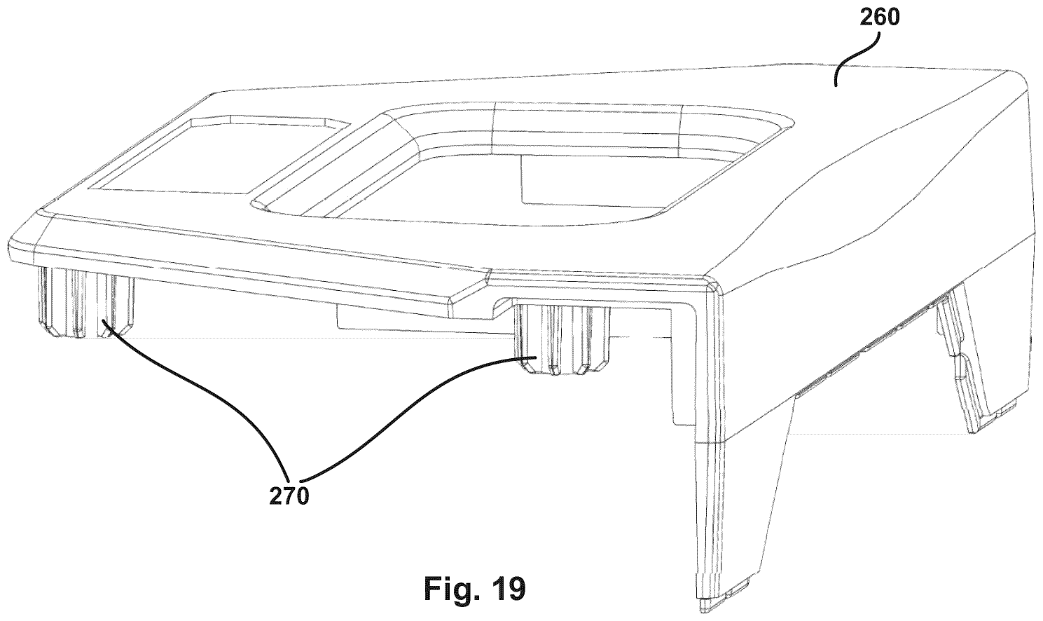

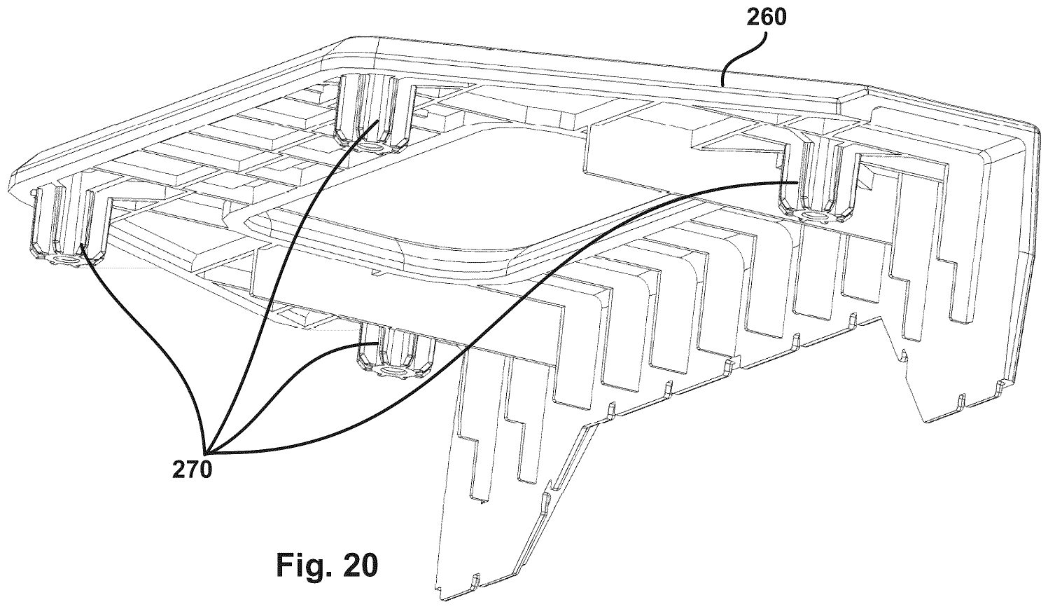

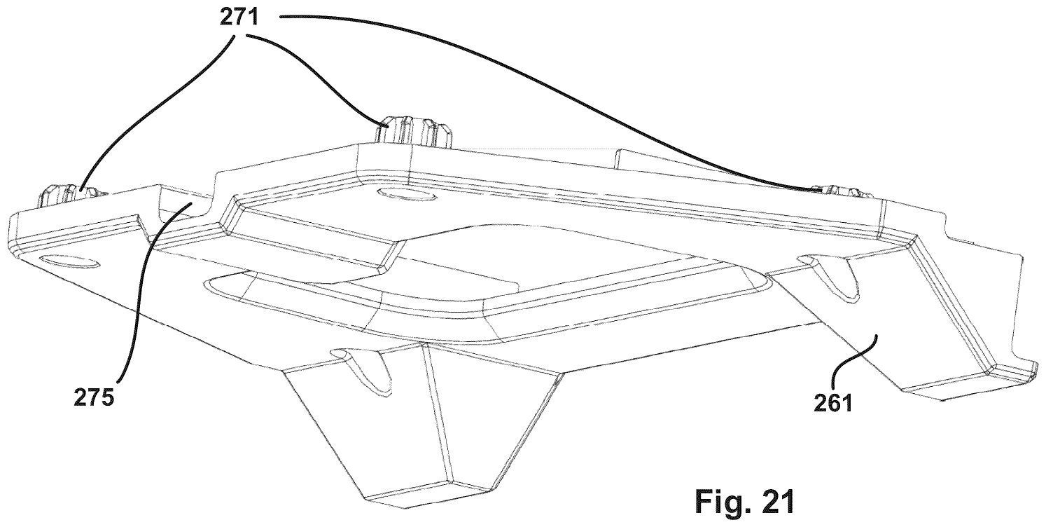

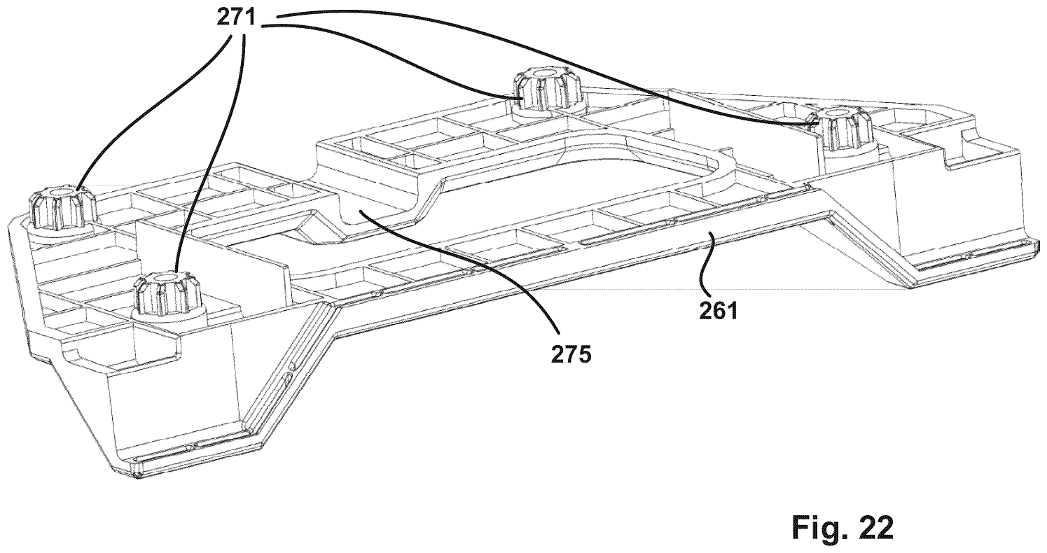

FIG. 19 shows a top view of the top handle plate 260. FIG. 20 shows a bottom view of the top handle plate 260. As shown in FIGS. 19 and 20, the top handle plate 260 includes bosses 270. FIG. 21 shows a bottom view of the bottom handle plate 261. FIG. 22 shows a top view of the bottom handle plate 261. As shown in FIGS. 21 and 22, the bottom handle plate 261 includes bosses 271. As shown in FIG. 18, the bosses 270 are aligned with the bosses 271.

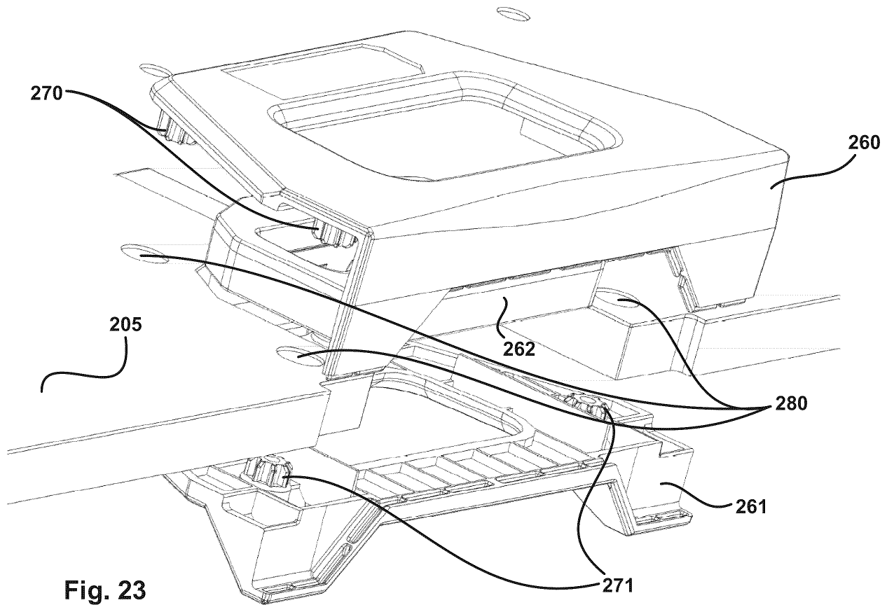

As is apparent from the exploded view of FIG. 23, in an example embodiment of the present invention, when the handle 210 is installed onto the tray 205, a portion of a perimeter of the top handle plate 260 extends over the tray 205, and a portion of a perimeter of the bottom handle plate 261 extends below the tray 205. The tray 205 includes bores 280, with the bosses 270 extending into the tops of the bores 280 and the bosses 271 extending into the bottoms of the bores 280. Fasteners, such as screws or the like, can be fastened so that they extend through the bores 280 and through the aligned bosses 270 and 271, fastening the top handle plate 260 and the bottom handle plate 261 to each other, sandwiching a portion of the tray 205 between said perimeters of the top handle plate 260 and bottom handle plate 261, with the core 262a being held within the housing formed by the fastened top handle plate 260 and bottom handle plate 261.

The bosses 270 and 271 ensure that there is at least a predefined distance between the bottom of the top handle plate 260 and the top of the bottom handle plate 261, to accommodate core 262a within the housing with sufficient clearance to be able to be shifted in the expansion and retraction directions, given that there may be variations in the thickness of the tray 205, for example due to manufacturing tolerances. The tray 205 can for example be formed of or predominantly of wood, plastic, fiberglass, or other composite material whose thickness may vary, for example, between unit to unit or even within the same unit, whereas the handle 210 can be made at least partially of plastic or cast metal, e.g., aluminum, with the bosses 270 and 271 ensuring the correct distance despite the possibly varying thickness of the wood. In an example embodiment, the handle 210 is made of cast aluminum in a plastic surround. It is noted that in other examples, the tray 205 can be made of and/or include materials other than wood, e.g., plastic, a composite, and/or other material.

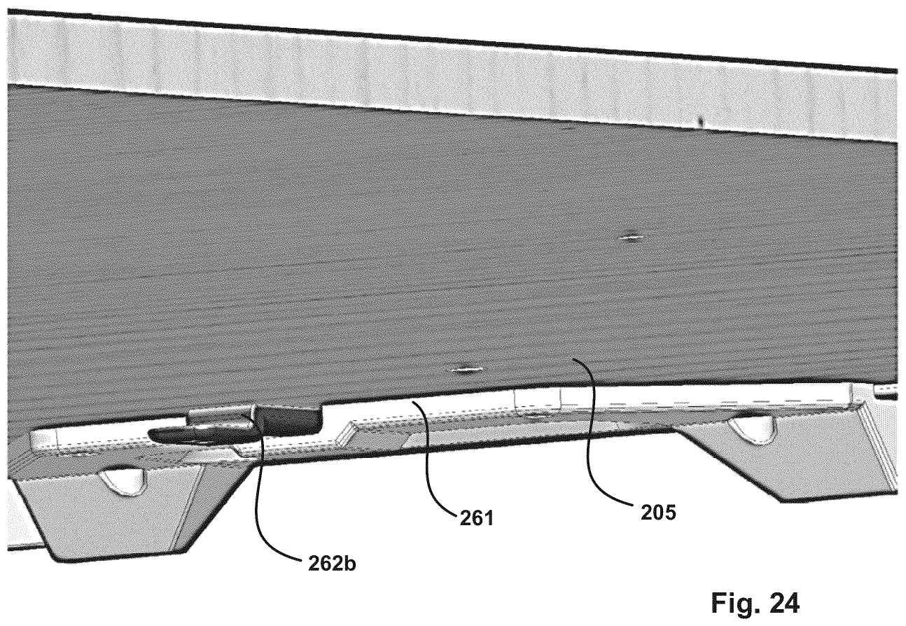

As shown in FIGS. 21 and 22, the bottom handle plate 261 has a channel 275. As can be seen in FIGS. 18 and 24, the channel 275 allows for cable holder tongue 262b to extend under a bottom of the tray 205, out of the housing formed by the fastened top handle plate 260 and bottom handle plate 261.

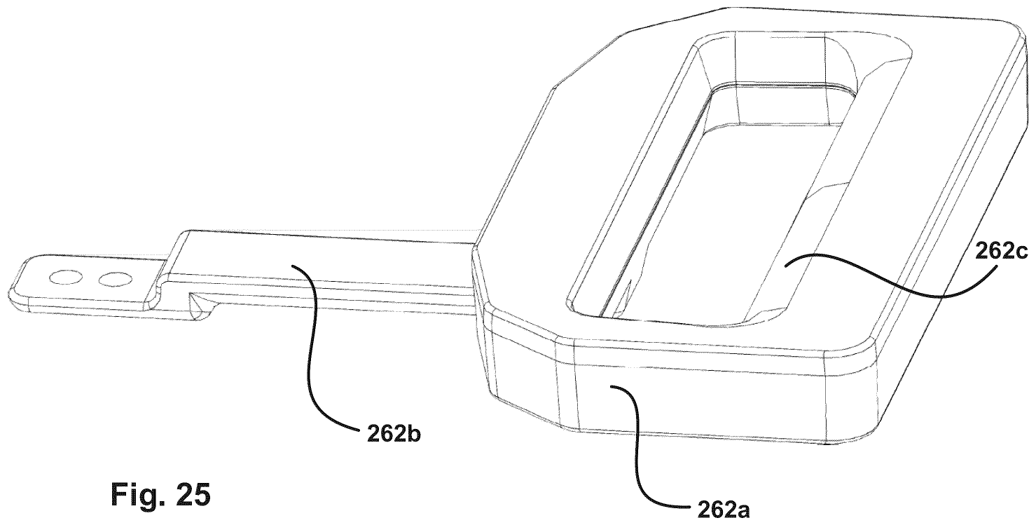

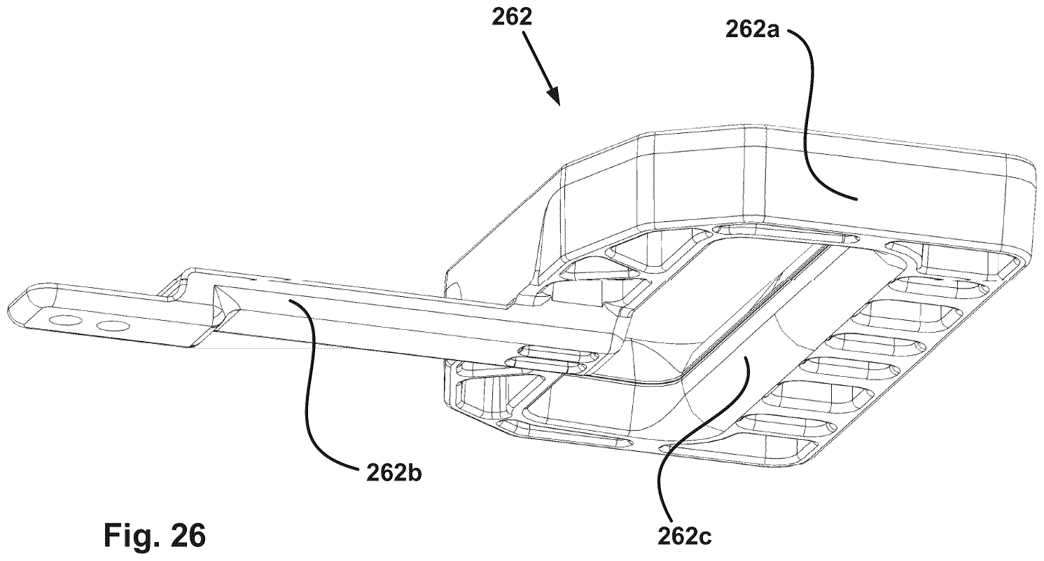

FIGS. 25 and 26 show, respectively, a top view of the latch controller 262 and a bottom view of the latch controller 262, according to an example embodiment of the present invention. The illustrated example latch controller 262 includes a contour 262c that, in a cross-section of a plane extending in the expansion and retraction directions, is, or is approximately, semi-circular. This curved contour 262c provided a comfortable surface against which a user can pull the latch controller 262 in the expansion direction.

According to the illustrated example, the handle 210 is thus constructed so that, when a user wishes to pull the tray 205 in the expansion direction, the user can insert the user's hand into the handle 210 with a palm of the user's hand laying against the contour 262c of the latch controller 262, and then pull on the handle 210 in the expansion direction with pressure of the user's palm being applied against the contour 262c, causing the latch controller 262 to first be shifted in the expansion direction inside the housing formed by the top handle plate 260 and bottom handle plate 261 prior to a shifting of said housing of the handle 210 in the expansion direction. In an example embodiment, this shifting of the latch controller 262 in the expansion direction releases the tray rails 208a and 208b to be able to be shifted relative to the base rails 207a and 207b as explained below.

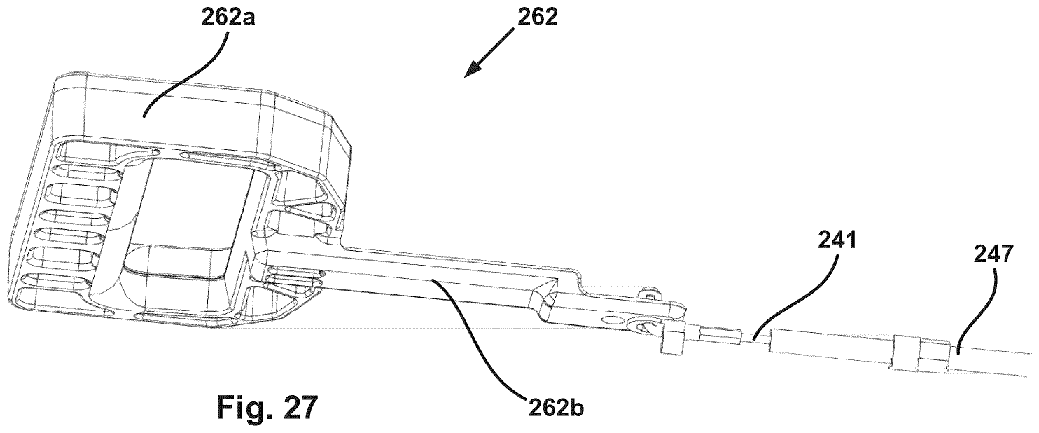

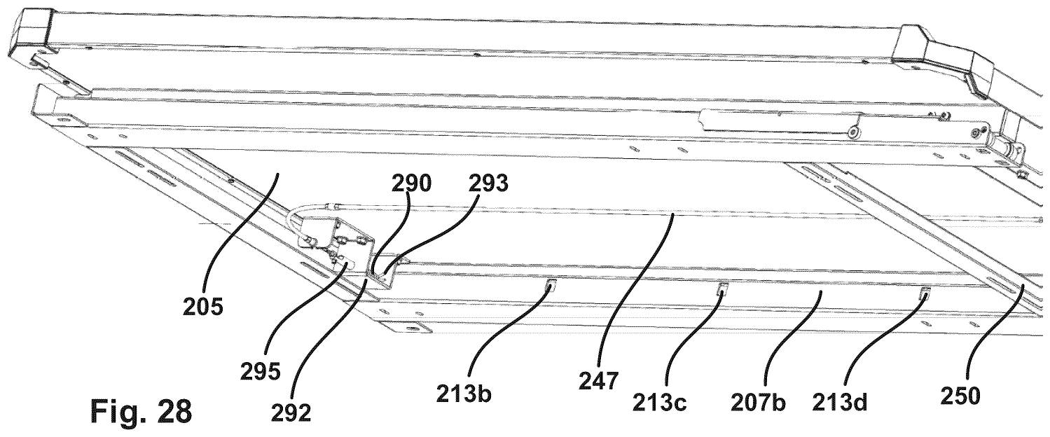

FIG. 27 provides a perspective view of the latch controller 262 with the spring cable 241 being connected to the cable holder tongue 262b. As shown in FIG. 5, the cable sheath 247, with the spring cable 241 extending therein, extends from the handle 210 towards a cabin-side of the tray 205. FIG. 28 shows a bottom perspective view of a portion of the cargo support 200 according to an example embodiment of the present invention, in which it is shown that near the cabin-side end of the tray 205, the cable sheath 247 with the spring cable 241 therein bend laterally towards the right base rail 207b (though in an alternative example embodiment, they can bend laterally towards the left base rail 207a, with the latch catch bores 213a-e mentioned below being in the left base rail 207a). As can be seen in FIGS. 4, 6, 7, 14, 15, and 28, the right base rail 207b has a plurality of latch catch bores 213a-e (although more or less latch catch bores can be provided in other example embodiments). Each of the latch catch bores 213a-e corresponds to and provides a respective locking position into which the cargo support 200 can be locked when in a locked state, from which locked state the cargo support 200 can be released by shifting the latch controller 262 in the expansion direction. Although the latch catch bores 213a-e are described as being in a sidewall of one of the base rails 207a/207b, in an alternative example embodiment, they can be in a sidewall formed by a different component of the base frame. For example, the base frame can include a dedicated latching bracket.

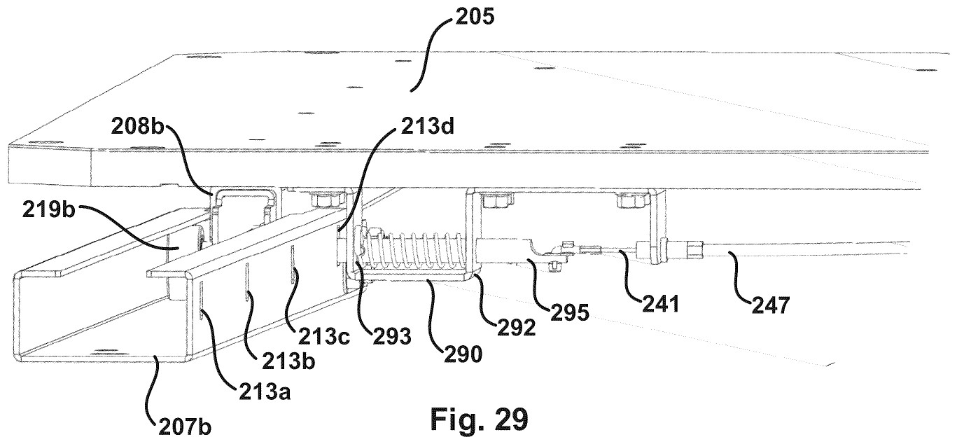

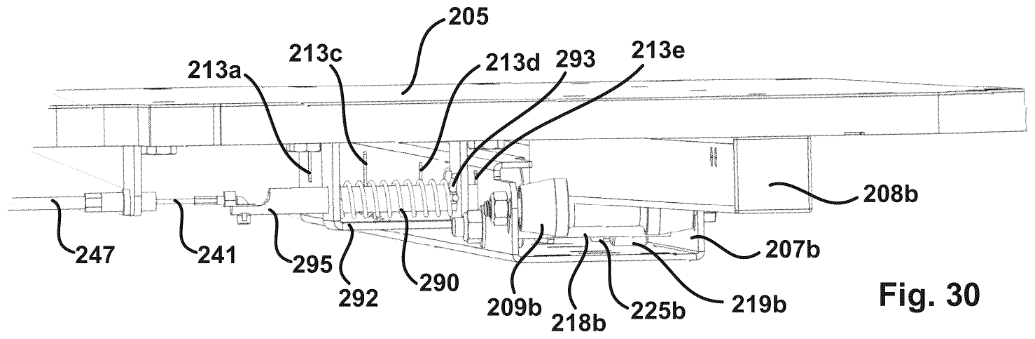

FIGS. 28-30 show a locking mechanism for locking the cargo support 200 in any of the locking positions. A spring holding bracket 292 is attached to the underside of the tray 205. A spring 290 extends between a pair of sidewalls of the spring holding bracket 292. A latch 295 extends in a lateral direction through and between the pair of sidewalls of the spring holding bracket 292, and a part of the latch 295 that is between the pair of sidewalls of the spring holding bracket 292 is surrounded by the spring 290. A cotter pin 293 extends through the latch 295 between the sidewalls of the spring holding bracket 292, near the sidewall proximal to the base rail 207b. The spring 290 is arranged with one end of the spring 290 abutting a right surface of a left one of the pair of sidewalls of the spring holding bracket 292 and another end of the spring 290 abutting against the cotter pin 293, thereby applying a force against the cotter pin 293, and thereby to the latch 295, in a direction towards the base rail 207b, to extend the latch 295 in the direction towards the base rail 207b until the cotter pin 293 abuts against the right one of the pair of sidewalls of the spring holding bracket 292 if the latch 295 is aligned with one of the latch catch bores 213a-e, in which case the latch 295 extends into the one of the latch catch bores 213a-e with which it is aligned. In an alternative example embodiment, the latch 295 includes an integrated flange against which the spring 290 applies force. Also, in an alternative example embodiment, the spring 290 need not be arranged circumferentially around the latch 295, but, for example, can be arranged at a side of the latch 295 and abut against the cotter pin 293 or flange of the latch 295. Additionally, although the spring 290 is shown to be a helical spring in the illustrated example embodiment, any other suitably appropriate spring can be used instead in other example embodiments.

The latch 295 also extends through the one of the pair of sidewalls of the spring holding bracket 292 that is more distal from the right base rail 207b, at which location the cable 241 is connected to the latch 295. When, while the latch 295 is locked into one of the latch catch bores 213a-e due to the force of the spring 290 against the cotter pin 293, the latch controller 262 is pulled in the expansion direction, this cause the cable 241 to also be pulled (a) in the expansion direction in the region in which the cable 241 extends longitudinally and (b) in a lateral direction away from the right base rail 207b in the region in which the cable 241 extends laterally. Due to the connection of the cable 241 to the latch 295, this causes the latch 295 to be pulled laterally against the force of the spring 290 in a direction away from the right base rail 207b, so that the latch 295 is removed from the one of the latch catch bores 213a-e through which the latch 295 had extended. This releases the latch 295 from the right base rail 207b, freeing the tray rails 208a and 208b to slide in the expansion and retraction directions relative to the base rails 207a and 207b.

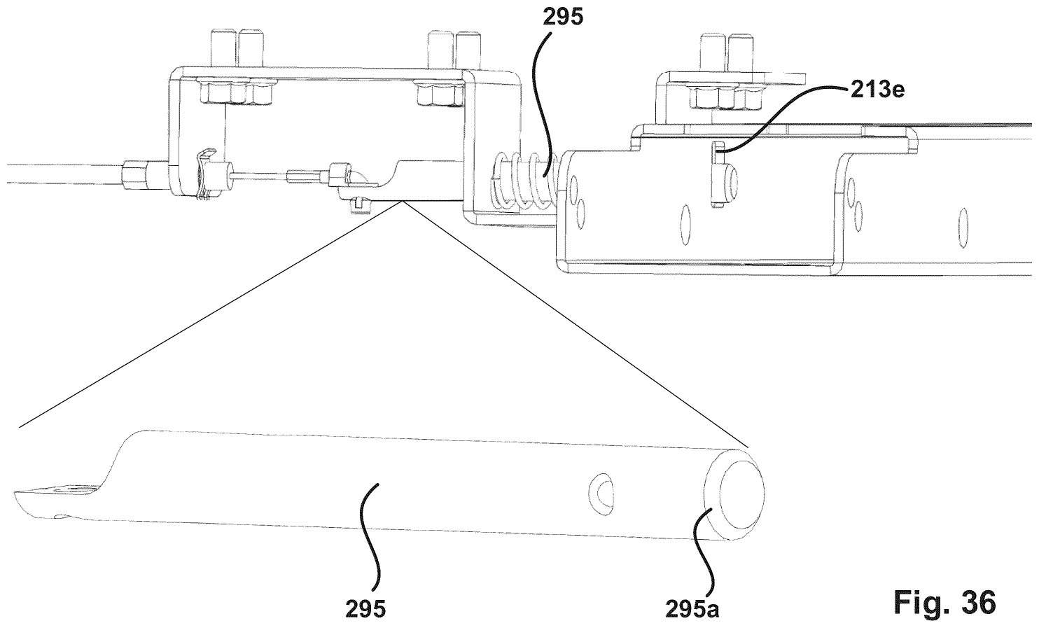

According to an example embodiment of the present invention, an end of the latch 295 facing towards the latch catch bores 213a-e are shaped in a manner by which their shape helps guide the latch 295 into the respective latch catch bores 213a-e without catching on edges of the respective latch catch bores 213a-e. For example, an upper part of FIG. 36 shows the latch 295 with an end thereof inserted into latch catch bore 213e. A lower part of FIG. 36 provides an isolated view of the latch 295, where it can be seen that the end thereof has a frustoconical shape, providing a chamfered edge 295a, which helps lead the latch 295 into any of the latch catch bores 213a-e with when substantially lined up with the respective one of the latch catch bores 213a-e. In alternative example embodiments, other similar edges can be used. For example, in an alternative example embodiment, the discussed end of the latch 295 is rounded.

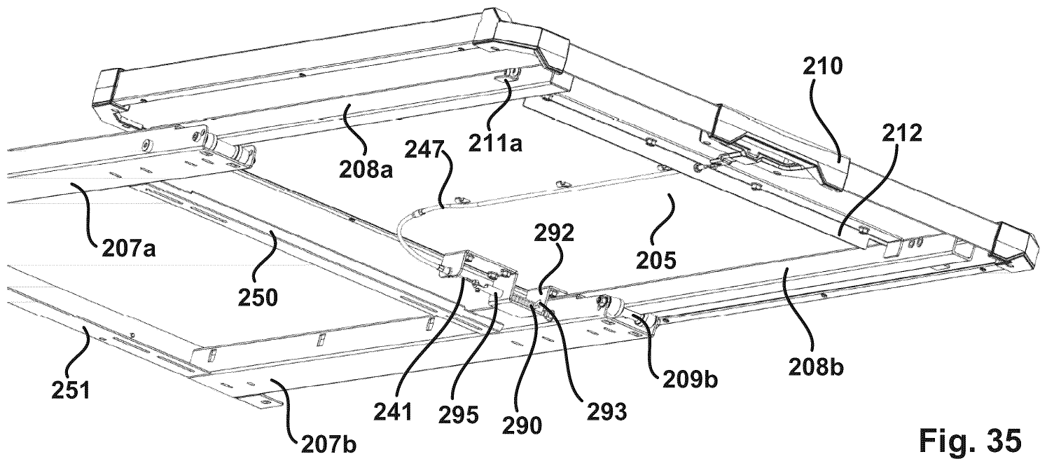

FIG. 35 shows an underside of the cargo support 200 when it is expanded to its maximum expansion state, showing the connection between the handle 210 and the locking mechanism. As shown in FIG. 35, the cable sheath 247 extends approximately from the cable holder tongue 262b, through a bore in the tray support 212, and onwards to the spring holding bracket 292. The tray support 212 and additional clips shown on the underside of the tray 205 stably hold the cable sheath 247 to the tray 205.

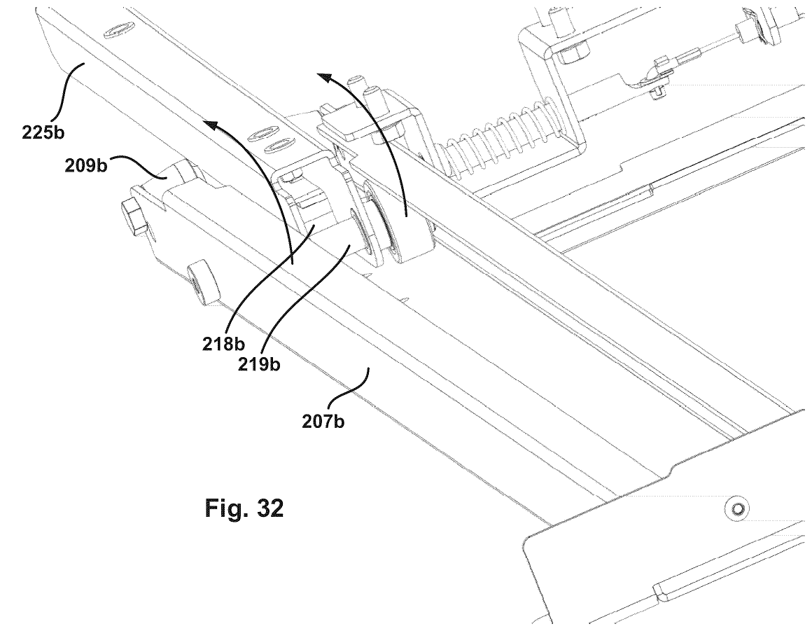

The cargo support 200 can be rated for a particular weight. According to an example embodiment of the present invention, most of the described parts can be incorporated into various versions of the cargo support 200 that differ from one another with respect to the cargo weight for which they are rated, with minor modifications between the different instances of the cargo support 200. For example, one instance of the cargo support 200 can be rated for carrying cargo up to a weight of 600 pounds, while another instance of the cargo support 200 can be rated for carrying cargo up to a weight of 1,000 pounds. For example, in an example embodiment, at least in the region of the tray rails 208a/208b that can be slid over the rollers 209a/209b, the tray rails 208a/208b of the instance of the cargo support 200 rated for 600 pounds can have cross-sectional dimensions of 1.5″ wide×1.5″ high; and at least in the region of the tray rails 208a/208b that can be slid over the rollers 209a/209b, the tray rails 208a/208b of the instance of the cargo support 200 rated for 1,000 pounds can have cross-sectional dimensions of 1.5″ wide×2″ high, the extra height providing an extra degree of stiffness for supporting the additional weight. However, as explained with respect to FIG. 31, when the cargo support 200 is fully extended, especially when loaded with its fully rated cargo weight, a rotationally upward force is generated at the cab-side of a fulcrum point. FIG. 32 is a view from the cab-side showing a portion of the cargo support 200 when the cargo support 200 is at its fully extended position, at which the tray roller 219a/219b abut the pin stops 218a/218b. In order to provide the necessary view, the tray 205 and the tray rail 207b has been removed from this figure. As explained above, the wheels of the tray rollers 219a/219b roll within the base rails 207a/207b under respective ones of the lips of the base rails 207a/207b, which are structured as c-channels. When the cargo support 200 is fully extended, especially when loaded with its fully rated cargo weight, as shown in FIGS. 31 and 32, the rotationally upward force generated at the cab-side of a fulcrum point causes the wheels of the tray rollers 219a/219b apply an upward force against the underside of the lips of the c-channel structured base rails 207a/207b. When the cargo support 200 is provided with the 1.5″×2″ tray rails 208a/208b so that the cargo support 200 is rated for 1,000 pounds, if the cargo support 200 is loaded with the maximum 1,000 pounds, the upward force of the wheels of the tray rollers 219a/219b against the underside of the lips of the c-channel can be so great so as to risk deformation of the lips of the c-channel.

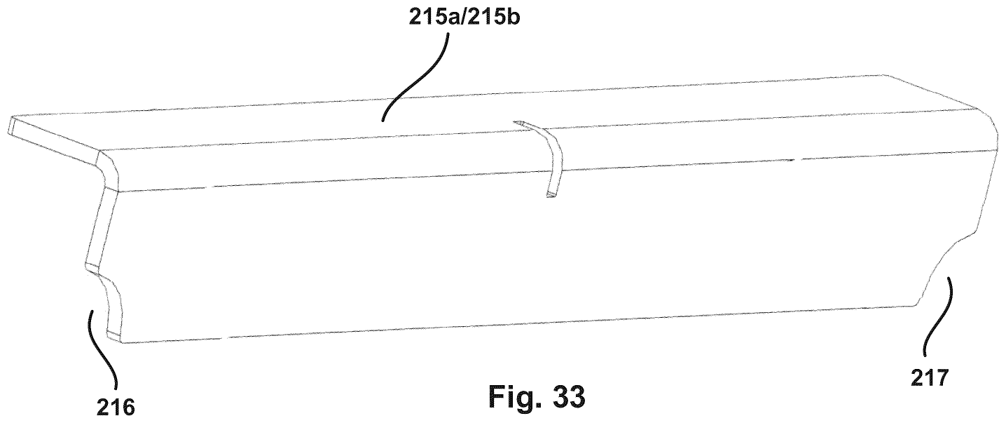

Therefore, in an example embodiment of the present invention, when the cargo support 200 is manufactured with the 1.5″×2″ tray rails 208a/208b, for the 1,000 pound weight rating, metal stiffeners 215a/215b, as shown in FIG. 33, made of bent sheet metal, are added respectively to the left and right base rails 207a/207b as shown in FIGS. 3, 5-7, 9-13, and 28. In an example embodiment, the stiffeners 215a/215b have an L-shaped cross-section, with one of the legs extending vertically up a laterally exterior one of the sidewalls of the c-channel and the other leg extending laterally over a laterally exterior one of the lips of the c-channel, for example, with the left stiffener 215a being installed on the left side of the left base rail 207a and the right stiffener 215b being installed on the right side of the tight base rail 207b.

As explained above, the tray rollers 219a/219b, at the most expanded position of the cargo support 200, butt up against the pin stops 218a/218b. Therefore, in an example embodiment of the present invention, the stiffeners 215a/215 are longitudinally positioned, e.g., welded to the base rails 207a/207b, at or immediately longitudinally adjacent to the longitudinal position of the pin stops 219a/219b. In an example embodiment of the present invention, the right-side stiffener 215b for the right base rail 207b has a left corner notch 216 at a bottom left corner of the vertical leg of the stiffener 215b and the left-side stiffener 215a for the left base rail 207a has a right corner notch 217 at a bottom right corner of the vertical leg of the stiffener 215a. In an example embodiment of the present invention, the stiffeners 215a/215b each includes both the left and right corner notches 216 and 217, as shown in FIG. 33, for ease of assembly, so that any of the stiffeners 215a/215b can be selected for either of the base rails 207a/207b at the time of assembly. The notches 216 and 217 are provided as a guide for proper longitudinal positioning with the tailgate end of the stiffeners 215a/215b being positioned at the pin stops 218a/218b, the tailgate-side notches 216/217 being positioned around the pin stops 218a/218b. For example, FIG. 10 shows stiffener 215b with circularly shaped notch 216 being arranged around part of the pin stop 218b.

Thus, according to an example embodiment of the present invention, a plurality of cargo supports 200 are manufactured, with a first subset of the cargo supports 200 being rated for carrying a first maximum weight, e.g., 600 pounds, and a second subset of the cargo supports 200 being rated for carrying a second maximum weight, e.g., 1,000 pounds, where (a) the tray rails 208a/208b of the first subset of the cargo supports 200 have a shorter profile than the tray rails 208a/208b of the second subset of the cargo supports 200, (b) stiffeners 215a/215b are welded to the base rails 207a/207b of the second subset of the cargo supports 200 but are not provided in the first subset of the cargo supports 200, and (c) the first and second subsets of the cargo supports 200 are otherwise identically structured. The described structures thus simplify the manufacturing process of cargo supports 200 rated for different maximum cargo weights, where the same components can be interchangeably selected for incorporation into any of the instances of the cargo support 200, except for (a) selecting between different versions of the tray rails 208a/208b, that differ with respect to their heights, and (b) selecting whether or not to add stiffeners 215a/215b.

According to an example embodiment of the present invention, a plurality of cargo supports 200 can be manufactured, which differ from one another with respect to their lengths. For example, a first subset of the cargo supports 200 can be selected for installation in a truck having a longitudinally short flatbed floor and a second subset of the cargo supports 200 can be selected for installation in a truck having a longitudinally longer flatbed floor. In example embodiment of the present invention, a simple manufacturing process is implemented, where the same parts are interchangeably selected for installation in either of these subsets of the cargo support 200, for example, except for (a) the selected tray 205, which can differ, between the different subsets, with respect to their lengths, (b) the selected left and right tray frame rods 301/302 (discussed below), which can differ, between the different subsets, with respect to their lengths, (c) the selected left and right base rails 207a/207b, which can differ, between the different subsets, with respect to their lengths (they can also differ with respect to the number of their latch catch bores 213), (d) the selected left and right tray rails 208a/208b, which can differ, between the different subsets, with respect to their lengths, and (e) the selected cables 241 and/or cable sheaths 247, which can differ, between the different subsets, with respect to their lengths. The other described components can be the same for both subsets of the cargo support 200, which subsets differ with respect to their lengths. For example, the same rollers 209a/209b can be installed in any of the subsets, the same handles 210 can be installed in any of the subsets, the same pin stops 218 can be installed in any of the subsets, the same rail stop brackets 225 can be installed in any of the subsets, the same tray rollers 219 can be installed in any of the subsets, the same tailgate and cab-side lateral base supports 250/251 can be installed in any of the subsets, the same tailgate side lateral tray support 212 can be installed in any of the subsets, the same locking mechanism, e.g., formed of the latch 295, spring 290, cotter pin 293, and spring holding bracket 292, can be installed in any of the subsets, and, other than the left and right tray frame rods 301/302, the same remaining parts of the tray frame framing the tray 205, which do not span the length of the tray 205, can be installed in any of the subsets. The described structures thus simplify the manufacturing process of cargo supports 200 having different lengths, where, with respect to a majority of the parts, the same components can be interchangeably selected for incorporation into any of the instances of the cargo support 200 that differ with respect to their lengths.

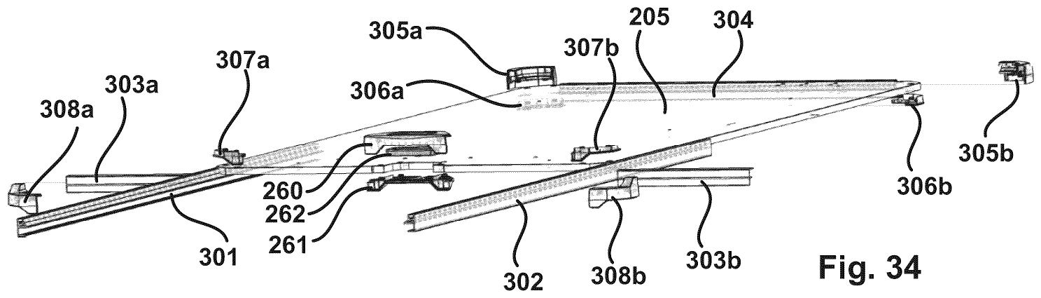

FIG. 34 provides an exploded and transparent view, according to an example embodiment of the present invention, of the tray 205, handle 210, and the tray frame, which, together with the handle 210, frames a perimeter of the tray 205. The tray frame includes a left tailgate-side frame rod 303a, which frames the left tailgate-side of the tray 205 to the left of the handle 210 (this part is shown to the left of the tray 205 in FIG. 34 because the figure provides the exploded view, and therefore, the part has been moved off to the side). The tray frame includes a right tailgate-side frame rod 303b, which frames the right tailgate-side of the tray 205 to the right of the handle 210 (this part is shown to the right of the tray 205 in FIG. 34 because the figure provides the exploded view, and therefore, the part has been moved off to the side). The tray frame includes the left tray frame rod 301, which frames a left side of the tray 205, and the right tray frame rod 302, which frames a right side of the tray 205. The tray frame includes a cab-side tray frame rod 304. The tray further includes corner caps at the corners of the tray 205 between which the left tray frame rod 301, the right tray frame rod 302, the combination of the left and right tailgate-side frame rods 303a/303b and handle 210, and the cab-side tray frame rod 304 extend. The corner caps include four two-piece caps, each for a respective corner of the tray 205. The corner caps include an upper left cab-side corner cap 305a, a lower left cab-side corner cap 306a, an upper right cab-side corner cap 305b, a lower right cab-side corner cap 306b.

Thus, example embodiments of the present invention provide features that improve the safety and ease of use of the cargo support 200. For example, the handle 210 is provides a prominent guide for the user to recognize a position at which to provide a force to the cargo support 200 to slide the tray 205 in the expansion and retraction directions. Additionally, the handle 210 provides a grip with which the user can easily apply the sliding control. The handle 210 also provides a comfortable surface against which the user can place the user's hand for manipulating the cargo support 200 into the sliding motions. The cargo support 200 also provides the safety feature of providing for locking the tray 205 in various expansion positions. The handle 210 provides an integrated control for transitioning the cargo support 200 between the locked states and the released states. Furthermore, the handle 210 is structured so that release of the cargo support 200 can easily be initiated by the user in a fluid motion of pulling upon the handle 210, which is a motion the user is expected to perform when the user desires to pull the cargo support 200 into a further expanded position. The cargo support 200 also includes pin stops 218a/218b, which prevent over-extension of the tray 205 to a position at which the base rails 207a/207b might become deformed by a rotational motion due to the weight of the cargo, which deformation could otherwise dangerously release the tray 205 to rotate downwards. The cargo support 200 also includes stiffeners 215a/215b for highly weight rated versions of the cargo support 200, which prevent the deformation of the base rails 207a/207b.

Additionally, example embodiments of the present invention are thus also directed to a feature by which the cargo support 200 can be flexibly installed, for example, so that the cargo support 200 can be installed in any of a plurality of vehicles which differ from each other, for example, with respect to one or more dimensions. For example, due to the first pair of roller support bores 230 and the second pair of roller support bores 231, the cargo support 200 can be installed in different vehicles whose respective tailgate interior faces, when in the open horizontal position, are at different heights relative to their flatbed floors, with the tailgate end of the cargo support tray 205 being positioned at different respective vertical distances from the flatbed floor in the different vehicles, in order to keep the height of the tailgate end of the cargo support 200 as vertically close as possible to the flatbed floor in each case.

Additionally, example embodiments of the present invention are thus also directed to providing safety of use by ensuring sufficiency of the strength of base rails at the position of the first and second pairs of the roller support bores 230/231, by positioning them horizontally offset from one another.

Additionally, example embodiments of the present invention are thus also directed to improving components of the cargo support 200 for ease of manufacture, by allowing for the components to be easily selected for alternative installation into any of different subsets of the cargo support 200 that differ with respect to their maximum cargo weight capacities.

Additionally, example embodiments of the present invention are thus also directed to improving components of the cargo support 200 for ease of manufacture, by allowing for the components to be easily selected for alternative installation into any of different subsets of the cargo support 200 that differ with respect to their lengths.

Additionally, example embodiments of the present invention are thus also directed to improving components of the cargo support 200 for ease of manufacture, by structuring stiffeners 215a/215b so that they can interchangeably be used for installation on the left base rail 207a or the right base rail 207b.

Additionally, example embodiments of the present invention are thus also directed to improving components of the cargo support 200 for ease of manufacture, by providing increased manufacturing tolerances, for example due to provision of bosses 270 and 271 (it is noted that in an example embodiment of the present invention, the upper and lower parts of the corner caps can similarly include bosses for increased tolerances with respect to the thickness of the tray 205, with the corner caps being made of plastic).

Additionally, example embodiments of the present invention are thus also directed to improving components of the cargo support 200 for ease of manufacture, by providing increased tolerances with respect to misalignments between the base rails 207a/207b and/or tray rails 208a/208b relative to one another, while also guarding against wobbling of the tray 205 by providing for greater lateral distance between one of the tray rails 208a/208b relative to its respective supporting roller 209a/209b than the lateral distance between the other one of the tray rails 208a/208b relative to its respective supporting roller 209a/209b.

The described embodiments are not intended to be limiting. Other similar parts, structures, and assemblies that provide the same or similar functions as those explicitly detailed herein are also considered to fall within the scope of this invention. Additionally, non-explicitly mentioned equivalent parts, whether known or developed in the future, that perform substantially the same function in substantially the same way to achieve substantially the same result, are also incorporated. For example, while certain parts have been described above as separate parts, in other example embodiments, those parts can be formed as a single integrated part. For example, in an alternative example embodiment, the tray rail stops 225a/225b can be formed integrally with the tray rails 208a/208b, or the tray assembly including the tray 205 and the tray frame can in alternative example embodiment be provided as a single integral tray part. Additionally, various features described above can be provided in combination in a single embodiment of the cargo support 200. Alternatively, other embodiments can include one or more of the described features and need not include all of the described features. Additionally, it is noted that the term “bores,” as used herein, is not intended to be limited to having a profile of any particular shape. For example, the bores can be circular, oval, rectangular, or square, or can have any other shape. For example, FIGS. 7, 14, and 36 show bores 213a-e as having a square or rectangular shape.

What is claimed is:

1. A cargo support comprising:
a tray that has a top face, a bottom face, first and second sides that extend laterally, and third and fourth sides that extend longitudinally;
a first tray rail that is coupled directly or indirectly to the bottom face of the tray;
a second tray rail that is coupled directly or indirectly to the bottom face of the tray and that extends longitudinally and parallel to the first tray rail; and
a base frame that includes a first base rail and a second base rail that extend longitudinally and parallel to each other and that each has a first end and a second end;
wherein:
the base frame including bores via which the base frame is fastenable to a flatbed floor of a vehicle;
the first and second tray rails are slidable relative to the first and second base rails, respectively, so that the tray is longitudinally slidable relative to the base frame:
in an expansion direction from a retracted state of the cargo support to one or more expanded states of the cargo support in which the first side of the tray shifts towards the second ends of the first and second base rails and the second side of the tray shifts away from the second ends of the first and second base rails; and
in a retraction direction from the one or more expanded states to the retracted state in which the first side of the tray shifts towards the first ends of the first and second base rails and the second side of the tray shifts towards the second ends of the first and second base rails; and
the tray has a cutout in a region of the tray that is at the second side of the tray for a handle that is pullable for initiating a sliding of the tray in the expansion direction.

2. The cargo support as recited in claim 1, wherein the handle is an integral part of the tray formed by the cutout.

3. The cargo support as recited in claim 1, further comprising the handle, the handle being fastened to the tray at a perimeter of the cutout.

4. The cargo support as recited in claim 3, wherein:
the handle includes an upper handle fixture, at least a part of an interior side of which is over and faces a part of the top face of the tray, and a lower handle fixture, at least a part of an interior side of which is under and faces a part of the bottom face of the tray; and
at least one of (a) the interior side of the upper handle fixture and (b) the interior side of the lower handle fixture includes a respective plurality of bosses extending from a base section of the respective fixture towards the other of the fixtures, thereby ensuring a predefined minimum vertical distance between an exterior face of the upper handle fixture and an exterior face of the lower handle fixture.

5. The cargo support as recited in claim 4, wherein each of the interior side of the upper handle fixture and the interior side of the lower handle fixture includes the respective plurality of bosses.

6. The cargo support as recited in claim 4, wherein each boss of at least a subset of the bosses includes a bore through which a respective fastener extends to fasten to the upper and lower handle fixtures to each other and to the tray.

7. The cargo support as recited in claim 6, wherein the tray includes a plurality of throughholes and each of the at least the subset of the bosses is positioned at least partly within a respective one of the throughholes, with a respective one of the fasteners of the respective boss extending through the respective throughhole.

8. The cargo support as recited in claim 7, wherein the respective radii of the at least the subset of the bosses and the radii of the respective throughholes within which the at least the subset of the bosses are positioned are dimensioned so that there is a friction fit connection between the at least the subset of the bosses and the respective throughholes within which the at least the subset of the bosses are positioned.

9. The cargo support as recited in claim 4, wherein at least a region of the tray having the part of the top face of the tray over which the at least the part of the interior side of the upper handle fixture is positioned and having the part of the bottom face of the tray under which the at least the part of the interior side of the lower handle fixture is positioned is formed of wood, plastic, fiberglass, or other composite material, and the upper and lower handle fixtures are made at least partially of plastic or cast metal.

10. The cargo support as recited in claim 3, wherein the handle includes a housing and a latch control, at least a part of the latch control being slidable in the expansion and retraction directions within the housing and relative to the housing and the tray.

11. The cargo support as recited in claim 10, wherein:
the housing includes an upper handle fixture, at least a part of an interior side of which is over and faces a part of the top face of the tray, and a lower handle fixture, at least a part of an interior side of which is under and faces a part of the bottom face of the tray; and
at least one of (a) the interior side of the upper handle fixture and (b) the interior side of the lower handle fixture includes a respective plurality of bosses extending from a base section of the respective fixture towards the other of the fixtures, thereby ensuring a predefined minimum vertical void within the housing for accommodating the at least the part of the latch control within the housing.

12. The cargo support as recited in claim 10, wherein, when the tray is any of at least a subset of positions relative to the base frame, the latch control (I) when shifted relative to the housing in the expansion direction, transitions the cargo support from (a) a locked state in which the longitudinal sliding of the tray relative to the base frame in the expansion and retraction directions is prevented into (b) an unlocked state in which the tray is slidable relative to the base frame in the expansion and retraction directions, and (II) when shifted relative to the housing in the retraction direction, transitions the cargo support from the unlocked state into the locked state.

13. The cargo support as recited in claim 10, wherein along an entire length of at least a portion of a surface of the latch control that faces towards the first side of the tray, the surface of the latch control has a semicircular cross-section.

14. A cargo support comprising:
a tray;
a first tray rail that is coupled directly or indirectly to a bottom face of the tray;
a second tray rail that is coupled directly or indirectly to the bottom face of the tray and that extends longitudinally and parallel to the first tray rail;
a base frame that includes a first base rail and a second base rail that extend longitudinally and parallel to each other; and
a latch arrangement;
wherein:
the base frame includes bores via which the base frame is fastenable to a flatbed floor of a vehicle;
the first and second tray rails are slidable relative to the first and second base rails, respectively, so that the tray is longitudinally slidable relative to the base frame (a) in an expansion direction from a retracted state of the cargo support to one or more expanded states of the cargo support and (b) in a retraction direction from any of the one or more expanded states to the retracted state;
the base frame includes a plurality of latch catch bores in a sidewall;
the latch arrangement includes:
a latch whose longitudinal position relative to the first and second tray rails is fixed and that is, at different times, insertable into, and removable from, each of the plurality of latch catch bores;
a latch control; and
a cord that extends from the latch control to the latch; and
the latch control is manually shiftable:
(I) in one direction, causing the cord to pull the latch away from the sidewall, to, when the latch is inserted in any of the plurality of latch catch bores, transition the cargo support from (a) a locked state in which the longitudinal sliding of the tray relative to the base frame in the expansion and retraction directions is prevented into (b) an unlocked state in which the tray is slidable relative to the base frame in the expansion and retraction directions; and
(II) in another direction, causing the cord to (a) shift and (b) when the latch is aligned with in any respective one of the plurality of latch catch bores, release the latch to shift into the respective one of the plurality of latch catch bores, thereby transitioning the cargo support from the unlocked locked state into the locked state.

15. The cargo support as recited in claim 14, wherein the one direction is the expansion direction, and the other direction is the retraction direction.

16. The cargo support as recited in claim 14, wherein the latch arrangement further includes a spring that biases the latch toward the sidewall.

17. The cargo support as recited in claim 16, wherein the spring applies an expansion force against a flange of the latch or against a component connected to the latch.

18. The cargo support as recited in claim 17, wherein the spring is a helical spring through which a portion of the latch extends.

19. The cargo support as recited in claim 16, wherein the spring applies an expansion force against a retaining surface that is connected to or is part of the latch.

20. The cargo support as recited in claim 14, further comprising a handle that includes a housing fixed to the tray and a latch controller (a) a part of which is arranged inside the housing and is shiftable inside the housing in the expansion and retraction directions and (b) that includes a tongue that (i) extends from inside the housing to outside of the housing in the retraction direction and (ii) is connected to the cord, so that a pulling of the latch controller relative to the housing in the expansion direction causes the cord to pull the latch away from the sidewall.

21. The cargo support as recited in claim 14, wherein the sidewall having the plurality of latch catch bores is a sidewall of the first base rail that faces the second base rail.

22. The cargo support as recited in claim 14, wherein an end face of the latch that faces towards a plane in which the latch catch bores are positioned is chamfered.

23. A cargo support comprising:
a tray;
a first tray rail that extends longitudinally and is coupled directly or indirectly to a bottom face of the tray;
a second tray rail that extends longitudinally and is coupled directly or indirectly to the bottom face of the tray;
a base frame that includes a first base rail and a second base rail that extend longitudinally;
a first roller that is attached to, and laterally extends across, the first base rail; and
a second roller that is attached to, and laterally extends across, the second base rail;
wherein:
each of the first and second rollers includes (a) laterally exterior sections and (b) a tubular laterally interior section extending laterally between the exterior sections, the exterior sections and the interior section all being concentrically aligned along a common axis, the interior section being radially smaller than the exterior sections, so that there are respective radial steps at respective transitions from each of the exterior sections to the interior section, thereby forming a circumferential groove;
a bottom of the first tray rail is supported, in the groove of the first roller, by a top of the interior section of the first roller;
a bottom of the second tray rail is supported, in the groove of the second roller, by a top of the interior section of the second roller;
a difference between a width of the groove of the first roller to a width of a region of the first tray rail that is supported by the top of the interior section of the first roller is greater than a difference between a width of the groove of the second roller to a width of a region of the second tray rail that is supported by the top of the interior section of the first roller; and
the first and second tray rails are slidable relative to the first and second base rails, respectively, with a corresponding spinning of the first and second rollers, so that the tray is longitudinally slidable relative to the base frame (a) in an expansion direction from a retracted state of the cargo support to one or more expanded states of the cargo support and (b) in a retraction direction from any of the one or more expanded states to the retracted state.

24. A cargo support comprising:
a tray;
a first tray rail that extends longitudinally and is coupled directly or indirectly to a bottom face of the tray;
a second tray rail that extends longitudinally and is coupled directly or indirectly to the bottom face of the tray;
a base frame that includes a first base rail and a second base rail that extend longitudinally;
a first roller that is attached to, and laterally extends across, the first base rail and that supports a bottom of the first tray rail; and
a second roller that is attached to, and laterally extends across, the second base rail and that supports a bottom of the second tray rail;
wherein:
the first and second tray rails are slidable relative to the first and second base rails, respectively, with a corresponding spinning of the first and second rollers, so that the tray is longitudinally slidable relative to the base frame (a) in an expansion direction from a retracted state of the cargo support to one or more expanded states of the cargo support and (b) in a retraction direction from any of the one or more expanded states to the retracted state;
each respective one of the first and second base rails includes (a) a first pair of bores in respective sidewalls of the base rail that share a same vertical coordinate and a same longitudinal coordinate as each other and (b) a second pair of bores in respective sidewalls of the base rail that (i) share a same vertical coordinate and a same longitudinal coordinate as each other and (ii) are vertically and laterally shifted from the first pair of bores;
the first roller and the first and second bores of the first base rail are structured such that the attachment of the first roller to the first base rail can alternatively (a) be made at, and using, the first pair of bores of the first base rail and (b) be made at, and using, the second pair of bores of the first base rail;
the first roller and the first and second bores of the second base rail are structured such that the attachment of the second roller to the second base rail can alternatively (a) be made at, and using, the first pair of bores of the second base rail and (b) be made at, and using, the second pair of bores of the second base rail; and
a vertical distance of an end of the tray, which is longitudinally shifted away from the base frame when the tray is longitudinally slid relative to the base frame in the expansion direction, from a bottom of the base frame differs depending on at which of the first and second pairs of bores the first and second rollers are attached to the first and second base rails.

25. A pair of cargo supports that are installable on a flatbed floor of a vehicle, the pair of cargo supports comprising:
a first cargo support; and
a second cargo support;
wherein:
with respect to each of the first and second cargo supports:
the respective cargo support includes:
a respective tray;
a respective first tray rail that is coupled directly or indirectly to
a bottom face of the respective tray;
a respective second tray rail that is coupled directly or indirectly to the bottom face of the respective tray and that extends longitudinally and parallel to the respective first tray rail; and
a respective base frame that is attachable to the flatbed floor and includes a respective first base rail and a respective second base rail that extend longitudinally and parallel to each other; and
the first and second tray rails of the respective cargo support are slidable relative to, respectively, the first and second base rails of the respective cargo support, so that the respective tray is longitudinally slidable relative to the respective base frame (a) in an expansion direction from a retracted state of the respective cargo support to one or more expanded states of the respective cargo support and (b) in a retraction direction from any of the one or more expanded states to the retracted state; and
the first cargo support, and not the second cargo support, includes, for each of the respective first and second base rails a respective stiffener attached to the respective first and second base rails.

26. The pair of cargo supports as recited in claim 25, wherein, other than that the first cargo support, and not the second cargo support, includes the respective stiffeners, the first and second cargo supports are structured the same as each other except that at least one of:
(I) a height of the first and second rails of the first cargo support in at least one longitudinal section of the first and second rails of the first cargo support is greater than a height of the first and second rails of the second cargo support in at least one longitudinal section of the first and second rails of the second cargo support that corresponds to the at least one longitudinal section of the first and second rails of the first cargo support; and
(II) a distance of extension of the tray rails in the expansion direction beyond a support of the base rails on which the tray rails roll is greater in the first cargo support than in the second cargo support.

27. The pair of cargo supports as recited in claim 26, wherein the height of the first and second rails of the first cargo support in the at least one longitudinal section of the first and second rails of the first cargo support is 2 inches, and the height of the first and second rails of the second cargo support in the at least one longitudinal section of the first and second rails of the second cargo support is 1.5 inches.

28. The pair of cargo supports as recited in claim 27, wherein the at least one longitudinal section of each of the first and second rails of each of the first and second cargo supports has a width of 1.5 inches.

29. The pair of cargo supports as recited in claim 25, wherein the first cargo support is rated for carrying cargo of up to a greater weight than the second cargo support.

30. The pair of cargo supports as recited in claim 25, wherein each of the stiffeners is welded to the respective base rail to which the respective stiffener is attached.

31. The pair of cargo supports as recited in claim 25, wherein:
each of the first and second cargo supports includes a respective stop pin that extends laterally within each of the first and second base rails;
with respect to each of the first and second tray rails of each of the first and second cargo supports, at least one respective flange extends vertically downward below a bottom of the at least one longitudinal section of the respective tray rail to at least as low as vertical coordinate of at least part of stop pin of a respective one of the base rails, the stop pins thereby limiting a degree by which the respective trays are longitudinally slidable relative to the respective base frames; and
with respect to each of the first and second base rails of the first cargo support, at least a part of the respective stiffener that is attached to the respective base rail extends longitudinally from a longitudinal coordinate that is adjacent to a longitudinal coordinate of the respective stop pin of the respective base rail along at least part of the respective base rail in which the at least one respective flange of a respective one of the tray rails is slidable.

32. The pair of cargo supports as recited in claim 31, wherein each of the stiffeners is notched at a bottom corner of the respective stiffener at an edge of the respective stiffener that is located at the respective stop pin of the respective base rail on to which the respective stiffener is attached, the notch having a shape that corresponds to a contour of a section of the respective stop pin that is outside of the respective base rail.

33. The pair of cargo supports as recited in claim 31, wherein, with respect to each of the tray rails, a respective tray rail roller (a) extends laterally through the at least one flange of the respective tray rail and (b) rolls within a respective one of the base rails at least partly below laterally extending lips of the respective one of the base rails when the respective tray of the respective cargo support is longitudinally slid relative to the respective base frame of the respective cargo support in the expansion and retraction directions.

34. A kit for assembly of a plurality of cargo supports that are installable on a flatbed floor of a vehicle, wherein each of the cargo supports includes a respective tray selected from a plurality of trays, respective tray rails that are selected from a plurality of tray rails and that are coupled directly or indirectly to a bottom face of the respective tray to extend in a longitudinal direction, and a respective base frame that includes, corresponding to each of the tray rails, a respective base rail selected from a plurality of base rails and installed so that the respective base rail extends in the longitudinal direction, wherein the tray rails of the respective cargo support are slidable relative to, respectively, the corresponding ones of the base rails so that the respective tray is longitudinally slidable relative to the respective base frame (a) in an expansion direction from a retracted state of the respective cargo support to one or more expanded states of the respective cargo support and (b) in a retraction direction from any of the one or more expanded states to the retracted state, and wherein the plurality of cargo supports include at least a first one or more cargo supports and a second one or more cargo supports, the first one or more cargo supports differing from the second one or more cargo supports with respect to a respective length of the respective cargo supports in the longitudinal direction, the kit comprising:
the plurality of trays, wherein the plurality of trays include one or more first trays that have a first tray length from which respective trays are selectable for assembly of the first one or more cargo supports and one or more second trays that have a second tray length different than the first tray length and from which respective trays are selectable for assembly of the second one or more cargo supports;
the plurality of tray rails, wherein the plurality of tray rails include one or more first tray rails that have a first tray rail length from which respective tray rails are selectable for assembly of the first one or more cargo supports and one or more second tray rails that have a second tray rail length different than the first tray rail length and from which respective tray rails are selectable for assembly of the second one or more cargo supports;
the plurality of base rails, wherein the plurality of base rails include one or more first base rails that have a first base rail length from which respective base rails are selectable for assembly of the first one or more cargo supports and one or more second base rails that have a second base rail length different than the first base rail length and from which respective base rails are selectable for assembly of the second one or more cargo supports;
a plurality of latch control cords, wherein the plurality of latch control cords include one or more first latch control cords that have a first cord length from which respective latch control cords are selectable for assembly of the first one or more cargo supports and one or more second latch control cords that have a second cord length different than the first cord length and from which respective latch control cords are selectable for assembly of the second one or more cargo supports;
a plurality of handles, each of which being alternatively selectable for installation on the trays of each of the first one or more cargo supports and the second one or more cargo supports, wherein, when installed, the respectively installed handle is connected to a respectively installed one of the latch control cords;
a plurality of latches, each of which being alternatively selectable for connection to the latch control cords of each of the first one or more cargo supports and the second one or more cargo supports, wherein, when installed, the respectively installed latch is insertable and removable from one of the respectively installed base rails by longitudinal shifting of at least a part of the respectively installed handle;
a plurality of springs, each of which being alternatively selectable for installation to apply a biasing force to the respectively installed latches of each of the first one or more cargo supports and the second one or more cargo supports;
a plurality of base rollers, each being alternatively selectable for attachment to respective ones of the base rails of each of the first one or more cargo supports and the second one or more cargo supports;
a plurality of stop pins, each being alternatively selectable for attachment to respective ones of the base rails of each of the first one or more cargo supports and the second one or more cargo supports, the stop pins limiting a degree to which the respective trays are extendable in the expansion direction; and
a plurality of tray rail rollers, each being alternatively selectable for (a) attachment to respective ones of the tray rails of each of the first one or more cargo supports and the second one or more cargo supports and (b) installation within respective ones of the base rails of each of the first one or more cargo supports and the second one or more cargo supports.
